(19) United States
(12) Patent Application Publication
(10) Pub. No.: US 2014/0092122 A1
(43) Pub. Date: Apr. 3, 2014

(54) IMAGE DISPLAY APPARATUS AND METHOD THEREFOR

(71) Applicant: KABUSHIKI KAISHA TOSHIBA, Tokyo (JP)

(72) Inventors: Yuma SANO, Kawasaki-Shi (JP); Ryosuke NONAKA, Yokohama-Shi (JP); Masahiro BABA, Yokohama-Shi (JP)

(73) Assignee: KABUSHIKI KAISHA TOSHIBA, Tokyo (JP)

(21) Appl. No.: 14/038,212

(22) Filed: Sep. 26, 2013

(30) Foreign Application Priority Data
Oct. 1, 2012 (JP) 2012-219675

(51) Int. Cl. G09G 5/02; G09G 5/06

(52) U.S. Cl. CPC G09G 5/02; G09G 5/06
USPC 345/601; 345/589

(57) ABSTRACT

There is provided an image display apparatus including: a setting unit, a correcting unit and a displaying unit. The setting unit sets an amount of correction value for at least one of lightness and chroma for each hues, wherein the amount of correction values are determined so that a relative relationship of evaluation values among the hues is kept from varying before and after correction, the evaluation values being values defined depending on lightness and chroma for the hues. The correcting unit obtains a corrected image by correcting at least one of the lightness and the chroma of the input image according to the amount of correction. The displaying unit displays the corrected image.

### CROSS REFERENCE TO RELATED APPLICATIONS

This application is based upon and claims the benefit of priority from the prior Japanese Patent Application No. 2012-219675 filed on Oct. 1, 2012, the entire contents of which are incorporated herein by reference.

### FIELD

Embodiments relate to an image display apparatus and a method therefor, particularly to an image quality adjustment technique for adjusting image quality factors, such as lightness and chroma for example, so as to correct a display image.

### BACKGROUND

There have been researches on image adjustment techniques for a user to correct an output image by adjustment of image quality factors for controlling the image quality of the output image on various kinds of image output devices. One conventional technique is to display a graph indicating the chroma characteristics of the individual hues of an output image on a screen so that the user adjusts the chroma characteristics of hues on the graph to thereby correct the chroma of a specified hue of the output image, for example. Another conventional technique is to display a window representing a three-dimensional color space on a screen for a pixel specified by the user in an input image and allow the user to adjust lightness, chroma, and hue while seeing changes in the color coordinates of the pixel.

However, these conventional techniques both have the drawback of the chroma and/or lightness of a particular hue being enhanced, resulting in imbalance of lightness and/or chroma among hues which causes an unnatural appearance, when the lightness and/or chroma of only a particular hue is corrected. Additionally, maintaining chroma and/or lightness balance among hues requires the user to finely adjust brightness and/or chroma of each hue, imposing heavy burden on the user.

### BRIEF DESCRIPTION OF THE DRAWINGS

FIG. 1 shows an image display apparatus according to a first embodiment;

FIG. 2 illustrates the operational flow of the image display apparatus of the first embodiment;

FIG. 3 shows an example of a display screen and an image quality adjustment screen on a displaying unit;

FIG. 4 is an enlarged view of the image quality adjustment screen;

FIG. 5 shows an exemplary image quality adjustment screen in which lightness, chroma, and hue can be adjusted for twelve hues;

FIG. 6 shows an exemplary image quality adjustment screen in which slide bars for respective hues are provided;

FIG. 7 shows the image quality adjustment screen in which the chroma of the red hue has adjusted in increasing direction;

FIG. 8 shows automated movement of slide bars;

FIG. 9 shows a display screen and an image quality adjustment screen displayed on the displaying unit according to a second embodiment;

FIG. 10 shows a display screen and an image quality adjustment screen displayed on the displaying unit according to a third embodiment;

FIG. 11 shows a display screen and an image quality adjustment screen displayed on the displaying unit according to a fourth embodiment;

FIG. 12 shows a display screen and an image quality adjustment screen displayed on the displaying unit according to a fifth embodiment;

FIG. 13 shows a display screen and an image quality adjustment screen displayed on the displaying unit according to a sixth embodiment;

FIG. 14 shows a configuration of the image display apparatus in a seventh embodiment;

FIG. 15 shows the configuration of the image display apparatus in an eighth embodiment; and

FIG. 16 shows the configuration of the image display apparatus in a ninth embodiment.

### DETAILED DESCRIPTION

According to some embodiments, there is provided an image display apparatus including: a setting unit, a correcting unit and a displaying unit.

The setting unit sets an amount of correction value for at least one of lightness and chroma for each hues, wherein the amount of correction values are determined so that a relative relationship of evaluation values among the hues is kept from varying before and after correction, the evaluation values being values defined depending on lightness and chroma for the hues.

The correcting unit obtains a corrected image by correcting at least one of the lightness and the chroma of the input image according to the amount of correction.

The displaying unit displays the corrected image.

Embodiments will now be described with reference to the drawings.

### First Embodiment

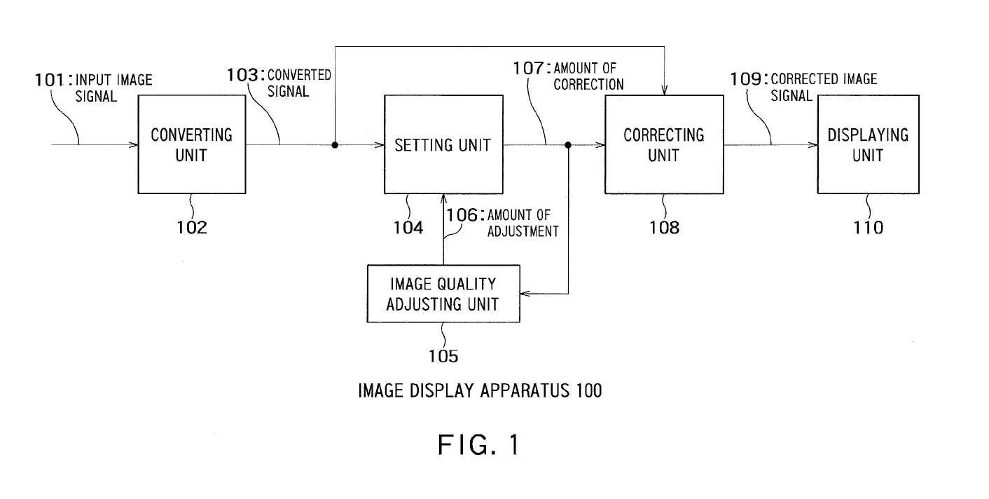

FIG. 1 shows an image display apparatus 100 according to a first embodiment of the invention.

The image display apparatus 100 of the first embodiment includes a converting unit 102, a setting unit 104, an image quality adjusting unit 105, a correcting unit 108, and a displaying unit 110.

The displaying unit 110 is a device for displaying images, and assumed to be a liquid crystal display by way of example in present embodiment. The displaying unit 110 may instead be a plasma or CRT display, or a projective device such as a projector.

The converting unit 102 applies color conversion to an input image signal 101 to convert the signal into a converted signal 103 representing lightness, chroma, and hue, and sends the converted signal 103 to the setting unit 104. The image quality adjusting unit 105 displays an image quality adjustment screen on a display screen of the displaying unit 110, and sends an amount of image quality adjustment 106 input through user operation to the setting unit 104. The setting unit 104 calculates an amount of image quality correction 107 for the input image signal 101 from the converted signal 103 and amount of image quality adjustment 106, and sends it to the image quality adjusting unit 105 and the correcting unit 108. The image quality adjusting unit 105 automatically changes the amount of image quality adjustment 106 for displayed on the image quality adjustment screen in accordance with the amount of image quality correction 107 and displays the changed same. The correcting unit 108 corrects the converted signal 103 in accordance with the amount of image quality correction 107, and sends a corrected image signal 109 to the displaying unit 110. The displaying unit 110 displays the corrected image signal 109.

The detailed operation of the image display apparatus 100 in the first embodiment will be now described.

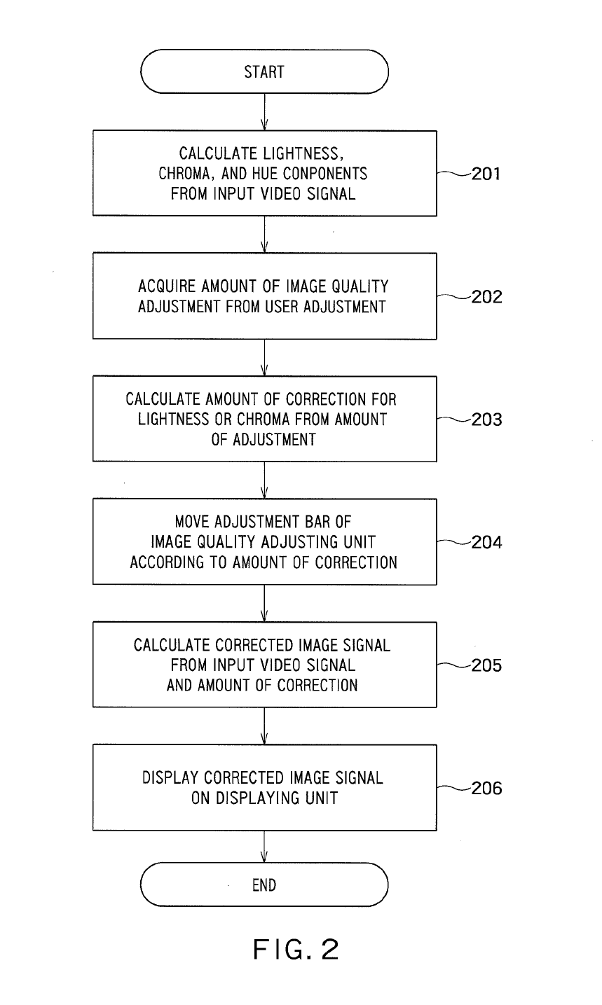

FIG. 2 is a flowchart illustrating the operation of the image display apparatus 100 in the first embodiment.

First, the converting unit 102 converts an input image signal 101 into a converted signal 103 representing lightness, chroma, and hue (S201). To be specific, the converting unit 102 first applies the gamma transform shown in Equation 1 to the gradation value of each of R, G, and B subpixels of each pixel included in the input image signal 101 inputted in RGB format.

$${R}_{in} = {( \frac{{R}_{in}^{′}}{255} )}^{γ} \\ {G}_{in} = {( \frac{{G}_{in}^{′}}{255} )}^{γ} \\ {B}_{in} = {( \frac{{B}_{in}^{′}}{255} )}^{γ} \qquad ( 1 )$$

In the equation, Rᵢₙ′, Gᵢₙ′, Bᵢₙ′ are the gradation values of R, G, and B subpixels in the input video signal, where the gradation value is represented in 8 bits (0 to 255). Rᵢₙ, Gᵢₙ, Bᵢₙ are gradation values after gamma transform on Rᵢₙ′, Gᵢₙ′, Bᵢₙ′, represented as a relative value between 0 and 1. The letter “γ” represents gamma coefficient.

Although in the first embodiment gamma transform is achieved according to Equation 1, gamma transform operation may be performed by preparing and referencing a lookup table in which input gradation values are associated with gamma-transformed gradation values in advance.

The aforementioned conversion is applied to R, G, and B subpixel values of all the pixels in the input video signal.

The converting unit 102 further converts Rᵢₙ, Gᵢₙ, Bᵢₙ into tristimulus values Xᵢₙ, Yᵢₙ, Zᵢₙ. The tristimulus values Xᵢₙ, Yᵢₙ, Zᵢₙ are determined from Rᵢₙ, Gᵢₙ, Bᵢₙ according to Equation 2:

$$[ \begin{matrix}{X}_{in} \\ {Y}_{in} \\ {Z}_{in}\end{matrix} ] = M [ \begin{matrix}{R}_{in} \\ {G}_{in} \\ {B}_{in}\end{matrix} ] \qquad ( 2 )$$

In the equation, “M” represents a 3×3 color conversion matrix and “M” is determined by the color reproduction range of the image to be displayed. The first embodiment employs a transformation matrix that converts the input video signal in accordance with the maximum color reproduction range that can be reproduced by the displaying unit.

The tristimulus values Xᵢₙ, Yᵢₙ, Zᵢₙ may be calculated from Rᵢₙ, Gᵢₙ, Bᵢₙ on a per-pixel basis by a preparing color conversion matrix as shown in Equation 2. Alternatively, Xᵢₙ, Yᵢₙ, Zᵢₙ may be determined by storing correspondence between Xᵢₙ, Yᵢₙ, Zᵢₙ, and Rᵢₙ′, Gᵢₙ′, Bᵢₙ′ in terms of color conversion in a lookup table and making reference to the lookup table based on Rᵢₙ′, Gᵢₙ′, Bᵢₙ′ for each pixel. When the input image signal is input in a format other than RGB, such as YUV, the XYZ tristimulus values may be determined by reference to a LUT that directly converts input signal values in YUV form or the like into XYZ tristimulus values.

Then, the tristimulus values Xᵢₙ, Yᵢₙ, Zᵢₙ determined by color conversion are converted into L*ᵢₙ, a*ᵢₙ, b*ᵢₙ in CIE L*a*b* color space. L*ᵢₙ, a*ᵢₙ, and b*ᵢₙ are calculated according to Equation 3:

$${L}_{in}^{*} = 116 \times f ( \frac{{Y}_{in}}{Yw} ) - 16 \\ {a}_{in}^{*} = 500 \times \{ f ( \frac{{X}_{in}}{Xw} ) - f ( \frac{{Y}_{in}}{Yw} ) \} \\ {b}_{in}^{*} = 200 \times \{ f ( \frac{{Y}_{in}}{Yw} ) - f ( \frac{{Z}_{in}}{Zw} ) \} \qquad ( 3 )$$

Here, f(Yᵢₙ/Y_{w}) is determined as shown in Equation 4, and f(Xᵢₙ/X_{w}) and f(Zᵢₙ/Z_{w}) are determined in a similar manner.

$$\begin{matrix}f ( \frac{{Y}_{in}}{Yw} ) = 7.787 \times ( \frac{{Y}_{in}}{Yw} ) + \frac{16}{116} & ( \frac{{Y}_{in}}{Yw} \leq 0.008856 ) \\ f ( \frac{{Y}_{in}}{Yw} ) = {( \frac{{Y}_{in}}{Yw} )}^{\frac{1}{3}} & ( 0.008856 < \frac{{Y}_{in}}{Yw} )\end{matrix} \qquad ( 4 )$$

X_{w}, Y_{w}, and Z_{w} represent tristimulus values for a Lambertian surface. Further, a*ᵢₙ and b*ᵢₙ are converted into chroma C*ᵢₙ and hue hᵢₙ by Equation 5:

$${C}_{in}^{*} = {\{ {( {a}_{in}^{*} )}^{2} + {( {b}_{in}^{*} )}^{2} \}}^{\frac{1}{2}} \\ {h}_{in} = {tan}^{- 1} ( \frac{{b}_{in}^{*}}{{a}_{in}^{*}} ) \qquad ( 5 )$$

The lightness L*ᵢₙ, chroma C*ᵢₙ, and hue hᵢₙ determined are sent to the setting unit 104 as the converted signal 103.

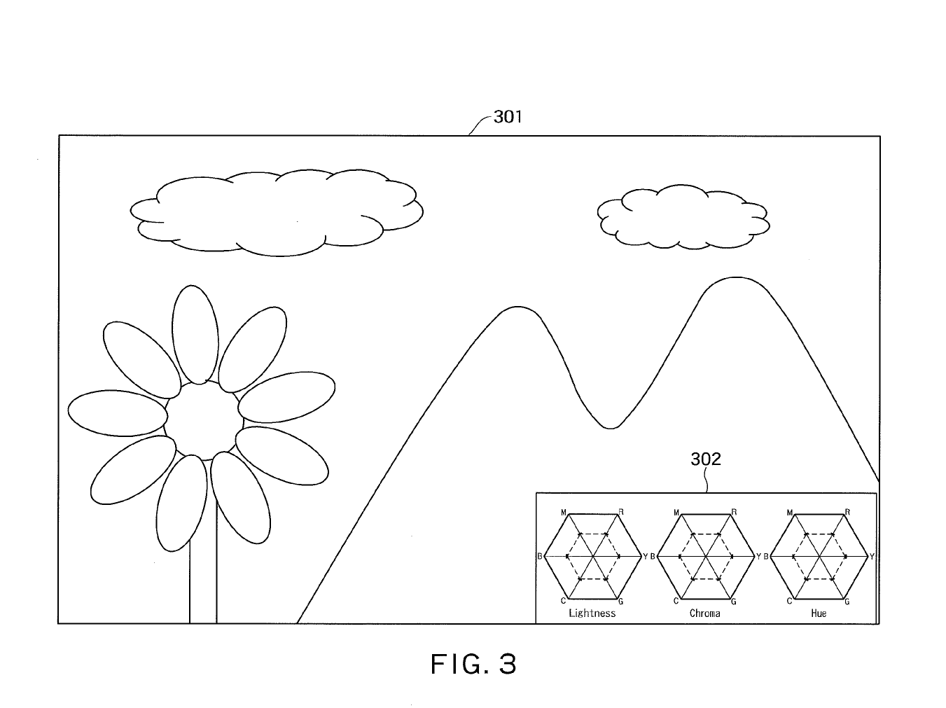

Then, the image quality adjusting unit 105 displays a screen for image quality adjustment on the display screen and the user uses the screen to adjust image quality (S202). FIG. 3 depicts exemplary display of a display screen 301 and an image quality adjustment screen 302 on the displaying unit 110. In FIG. 3, the image quality adjustment screen 302 is shown in a lower right portion of the screen, allowing the user to perform image quality adjustment.

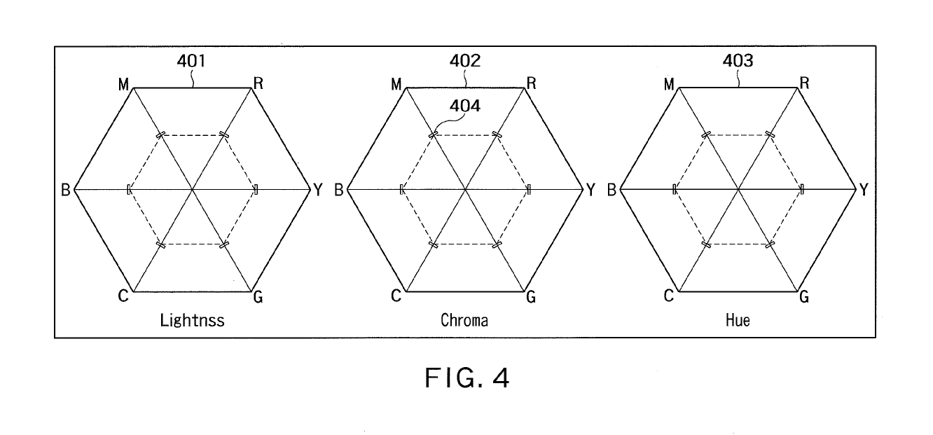

FIG. 4 is an enlarged view of the image quality adjustment screen 302.

In FIG. 4, three radar charts which respectively allow adjustment of lightness, chroma, and hue per hue are displayed. FIG. 4 includes a chart 401 allowing adjustment of lightness per hue, a chart 402 allowing adjustment of chroma per hue, and a chart 403 allowing adjustment of hue. Although the present embodiment takes three radar charts of lightness, chroma, and hue as the factors of image quality adjustment, this is not limitation.

In the status shown in FIG. 4, lightness, chroma, and hue are all in reference state and in unadjusted state (the amount of adjustment=0). The user can adjust the lightness, chroma, and hue of each hue by moving a slide bar 404 displayed per hue in the image quality adjustment screen 302 shown in FIG. 4.

In the charts 402 and 403 for adjusting lightness and chroma respectively, moving the slide bar outward in the radar chart sets a positive amount of adjustment, and moving the slide bar inward in the radar chart sets a negative amount of adjustment. On the chart 403 for hue adjustment, outward movement of the slide bar sets an amount of adjustment such that the hue changes clockwise on the chart 403 and inward movement sets an amount of adjustment such that the hue changes counterclockwise.

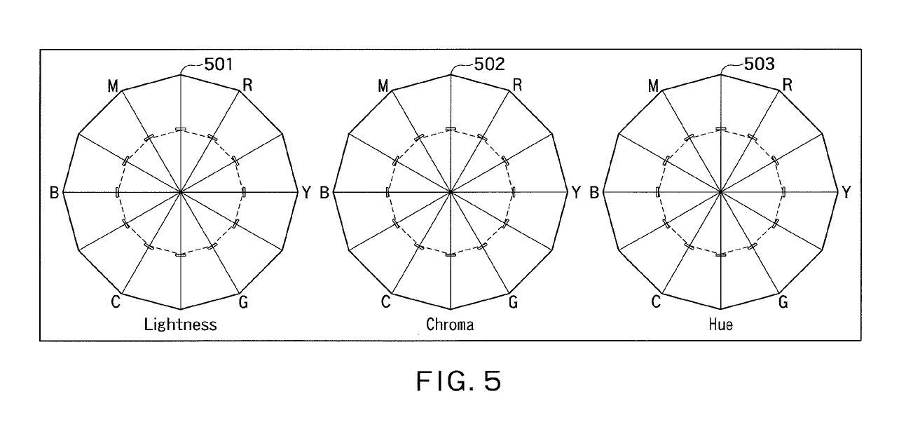

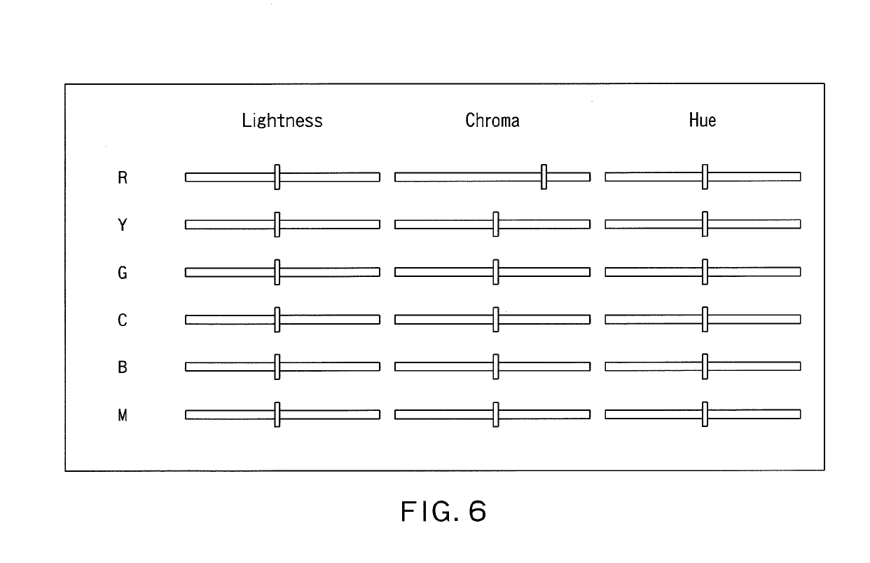

Although FIG. 4 illustrates a case where there are six hues for which lightness, chroma, and hue can be adjusted, the number of hues for adjustment is not limited to six; there may be twelve hues as shown in FIG. 5, or more. Also, although the adjustment slide bars in FIGS. 4 and 5 are disposed in a radar chart form, slide bars for the respective hues may be provided as shown in FIG. 6. The user can use the image quality adjustment screen 302 to adjust the lightness, chroma, or hue of a desired hue.

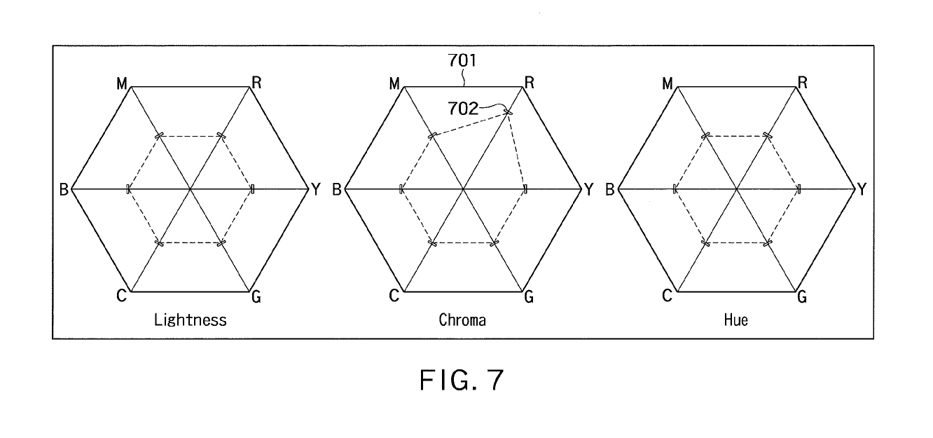

By way of example, FIG. 7 shows the image quality adjustment screen in which the user has made an adjustment for increasing the chroma of the red hue. It can be seen that in the image quality adjustment screen of FIG. 7, a slide bar 702 for the red hue in a radar chart 701 for controlling chroma has moved outward from the reference position.

The image quality adjusting unit 105 determines the hue chosen by the user and the amount of change in lightness, chroma, or hue in that hue from the amount of adjustment of image quality made by the user using the image quality adjustment screen 302, and sends them to the setting unit 104 as the amount of adjustment 106.

Then, the setting unit 104 sets the amounts of correction 107 for lightness and chroma for the input image on a per-hue basis from the converted signal 103 and the amount of adjustment 106 (S203). Specifically, it first calculates a corrected converted signal in the case that the lightness, chroma, or hue in the converted signal is corrected according to the amount of adjustment 106, for the hue indicated by the amount of adjustment 106.

Hereinbelow, the present embodiment assumes a case where the chroma of the red hue is varied by ΔC*ᵢₙ in the adjustment performed by the user. When a converted signal with the lightness of L*ₘ and chroma of C*ᵢₙ in the red hue is represented as (L*ᵢₙ, C*ᵢₙ, hᵢₙ(R)), a corrected converted signal corrected with the amount of adjustment 106 (L*ᵢₙ′, C*ᵢₙ′, hᵢₙ(R)′) is calculated as in Equation 6:

L*ᵢₙ′=L*ᵢₙ

C*ᵢₙ′=C*ᵢₙ+ΔC*ᵢₙ

hᵢₙ(R)′=hᵢₙ(R) (6)

The setting unit 104 then calculates perceived brightness for each of the converted signal (L*ᵢₙ, C*ᵢₙ, hᵢₙ(R)) and the corrected converted signal (L*ᵢₙ′, C*ᵢₙ′, hᵢₙ(R)′). The perceived brightness is described here. As known as the Helmholtz-Kohlrausch effect, when the lightness is the same, a chromatic color generally appears brighter than an achromatic to human eyes and it is perceived to be brighter as its vividness increases. Based on the Helmholtz-Kohlrausch effect, the embodiment assumes that the brightness B* perceived by human eyes is dependent on the lightness L*, chroma C*, and hue h of a target object, and defined by Equation 7:

B*=L*+(F(h)+k)×C* (7)

In the equation, “F” is a function that outputs different values depending on hue, and “k” is a constant. In accordance with Equation 7, perceived brightness B*ᵢₙ before adjustment for the hue adjusted by the user and perceived brightness B*ᵢₙ′ after adjustment are calculated as in Equation 8:

$${B}_{in}^{*} ( {L}_{in}^{*} , {C}_{in}^{*} , {h}_{in} ( R ) ) = {L}_{in}^{*} + ( F ( {h}_{in} ( R ) ) + k ) \times {C}_{in}^{*} \\ \begin{matrix}{B}_{in}^{* ′} ( {L}_{in}^{*} , {C}_{in}^{*} , {h}_{in} ( R ) ) = {L}_{in}^{* ′} + ( F ( {{h}_{in} ( R )}^{′} ) + k ) \times {C}_{in}^{* ′} \\ = {L}_{in}^{*} + ( F ( {h}_{in} ( R ) ) + k ) \times ( {C}_{in}^{*} + Δ {C}_{in}^{*} )\end{matrix} \qquad ( 8 )$$

Further, the ratio P of perceived brightnesses before and after the adjustment for the hue adjusted by the user is calculated for each of lightness and chroma values. The ratio of perceived brightness with the lightness of L*ᵢₙ and chroma of C*ᵢₙ after the user adjustment, P(L*ᵢₙ, C*ᵢₙ, hᵢₙ(R)), is calculated as in Equation 9:

$$\begin{matrix}P ( {L}_{in}^{*} , {C}_{in}^{*} , {h}_{in} ( R ) ) = \frac{{B}_{in}^{* ′} ( {L}_{in}^{*} , {C}_{in}^{*} , {h}_{in} ( R ) )}{{B}_{in}^{*} ( {L}_{in}^{*} , {C}_{in}^{*} , {h}_{in} ( R ) )} \\ = \frac{{L}_{in}^{*} + ( F ( {h}_{in} ( R ) ) + k ) \times ( {C}_{in}^{*} + Δ {C}_{in}^{*} )}{{L}_{in}^{*} + ( F ( {h}_{in} ( R ) ) + k ) \times {C}_{in}^{*}}\end{matrix} \qquad ( 9 )$$

Further, as shown in Equation 10, the ratio of perceived brightnesses P(L*ᵢₙ, C*ᵢₙ, hᵢₙ(R)) before and after the adjustment for the hue hᵢₙ(R) by the user is applied in common to all hues that have equal lightness and chroma. Thus, this ratio is defined as ratio Pₘₐₓ(L*ᵢₙ, C*ᵢₙ)

Pₘₐₓ(L*ᵢₙ,C*ᵢₙ)=P(L*ᵢₙ,C*ᵢₙ,hᵢₙ(R)) (10)

In the hue hᵢₙ(R) for which the user adjusted chroma, the perceived brightness has increased by the ratio Pₘₐₓ(L*ᵢₙ, C*₁ₙ) as the result of the user adjustment. Accordingly, by multiplying the perceived brightness of other hues for which the user did not adjust image quality by the ratio Pₘₐₓ(L*ᵢₙ, C*ᵢₙ), the ratio of perceived brightness among all hues that have equal lightness and chroma can be kept the same as the ratio before the user adjustment. In other words, variation in the relative relationship of an evaluation value (perceived brightness herein) among hues before and after the adjustment can be kept from varying. The brightness B*ₒᵤₜ (L*ᵢₙ, C*ᵢₙ, hᵢₙ) perceived when the perceived brightness B*ᵢₙ(L*ᵢₙ, C*ᵢₙ, hᵢₙ) with the lightness L*ᵢₙ and chroma C*ᵢₙ in hue hᵢₙ is multiplied by ratio Pₘₐₓ(L*ᵢₙ, C*ᵢₙ) is determined according to Equation 11:

B*ₒᵤₜ(L*ᵢₙ,C*ᵢₙ,hᵢₙ)=B*ᵢₙ(L*ᵢₙ,C*ᵢₙ,hᵢₙ)×Pₘₐₓ(L*ᵢₙ,C*ᵢₙ) (11)

Further, the difference ΔB*ₒᵤₜ(L*ᵢₙ, C*ᵢₙ, hᵢₙ) between the perceived brightnesses B*ᵢₙ(L*ᵢₙ, C*ᵢₙ, hᵢₙ) and B*ₒᵤₜ(L*ᵢₙ, C*ᵢₙ, hᵢₙ) is calculated according to Equation 12:

$$\begin{matrix}Δ {B}_{out}^{*} ( {L}_{in}^{*} , {C}_{in}^{*} , {h}_{in} ) = {B}_{out}^{*} ( {L}_{in}^{*} , {C}_{in}^{*} , {h}_{in} ) - {B}_{in}^{*} ( {L}_{in}^{*} , {C}_{in}^{*} , {h}_{in} ) \\ = \{ {P}_{max} ( {L}_{in}^{*} , {C}_{in}^{*} ) - 1 \} \times {B}_{in}^{*} ( {L}_{in}^{*} , {C}_{in}^{*} , {h}_{in} )\end{matrix} \qquad ( 12 )$$

The difference of perceived brightness ΔB*ₒᵤₜ(L*ᵢₙ, C*ᵢₙ, hᵢₙ) may also be approximated by setting the difference in perceived brightness in hue hᵢₙ(R) before and after the user adjustment determined by Equation 8, as shown in Equation 13. Setting with Equation 13 has an advantage of low computational complexity.

$$\begin{matrix}Δ {B}_{out}^{*} ( {L}_{in}^{*} , {C}_{in}^{*} , {h}_{in} ) = {B}_{in}^{* ′} ( {L}_{in}^{*} , {C}_{in}^{*} , {h}_{in} ( R ) ) - {B}_{in}^{*} ( {L}_{in}^{*} , {C}_{in}^{*} , {h}_{in} ( R ) ) \\ = ( F ( {h}_{in} ( R ) ) + k ) \times Δ {C}_{in}^{*}\end{matrix} \qquad ( 13 )$$

Next, from the difference of perceived brightness ΔB*ₒᵤₜ(L*ᵢₙ, C*ᵢₙ, hᵢₙ), the amounts of correction for lightness and chroma are established. For example, when the difference of perceived brightness is corrected entirely with lightness, the amount of lightness correction ΔL*ₙᵤₜ and the amount of chroma correction ΔC*ₙᵤₜ are determined as shown in Equation 14:

ΔL*ₒᵤₜ=ΔB*ₒᵤₜ(L*ᵢₙ,C*ᵢₙ,hᵢₙ)

ΔC*ₒᵤₜ=0 (14)

In contrast, when the difference of perceived brightness is corrected entirely with chroma, the amount of lightness correction ΔL*ₒᵤₜ and the amount of chroma correction ΔC*ₒᵤₜ are determined as in Equation 15:

$$Δ {L}_{out}^{*} = 0 \\ Δ {C}_{out}^{*} = \frac{Δ {B}_{out}^{*} ( {L}_{in}^{*} , {C}_{in}^{*} , {h}_{in} )}{( F ( {h}_{in} ) + k )} \qquad ( 15 )$$

It is also possible to divide the amount of correction for perceived brightness between lightness and chroma at a certain ratio as in Equation 16, where “α” is a variable between 0 and 1. The variable “α” may be user-configurable.

$$Δ {L}_{out}^{*} = Δ {B}_{out}^{*} ( {L}_{in}^{*} , {C}_{in}^{*} , {h}_{in} ) \times α \\ Δ {C}_{out}^{*} = \frac{Δ {B}_{out}^{*} ( {L}_{in}^{*} , {C}_{in}^{*} , {h}_{in} )}{( F ( {h}_{in} ) + k )} \times ( 1 - α ) \qquad ( 16 )$$

The amounts of correction 107 for lightness and chroma are sent to the image quality adjusting unit 105 and the correcting unit 108.

In response to the amounts of image quality correction 107 sent from the setting unit 104, the image quality adjusting unit 105 moves the adjustment slide bars for lightness and chroma of the image quality adjusting unit 105 (S204). More specifically, it converts the amounts of image quality correction 107 into the amounts of slide bar movement, and moves the slide bars by the amounts. Thereby, the amounts of correction 107 for lightness and chroma determined by the setting unit 104 can be visualized.

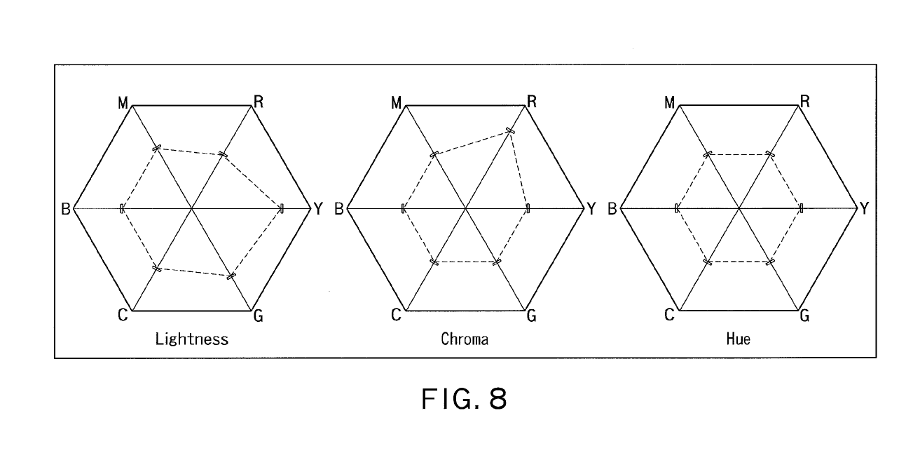

In response to the chroma adjustment for the red hue performed by the user as shown in FIG. 7, the amounts of correction for lightness and chroma 107 for each hue are calculated by the setting unit 104, and the slide bars of the image quality adjusting unit 105 automatically move into a state in which the lightness of each hue has increased by the amounts of correction 107 as shown in FIG. 8. Although the example in FIG. 8 shows correction of only lightness of all hues in response to chroma adjustment for the red hue, only the chroma of all hues may be corrected, or both lightness and chroma may be corrected.

The correcting unit 108 calculates the corrected image signal 109 from the amount of correction 107 and the converted signal 103 and sends it to the displaying unit 110 (S205).

First, from the amount of lightness correction ΔL*ₒᵤₜ, the amount of chroma correction ΔC*ₒᵤₜ, and converted signal (L*ᵢₙ, C*ᵢₙ, hᵢₙ), the corrected converted signal (L*ₒᵤₜ, C*ₒᵤₜ, hₒᵤₜ) is calculated according to Equation 17:

L*ₒᵤₜ=L*ᵢₙ+ΔL*ₒᵤₜ

C*ₒᵤₜ=C*ᵢₙ+ΔC*ₒᵤₜ

hₒᵤₜ=hᵢₙ (17)

Further, C*ₒᵤₜ and hₒᵤₜ are converted to a*ₒᵤₜ and b*ₒᵤₜ according to Equation 18:

a*ₒᵤₜ=C*ₒᵤₜ×cos(hₒᵤₜ)

b*ₒᵤₜ=C*ₒᵤₜ×sin(hₒᵤₜ) (18)

Further, L*ₒᵤₜ, a*ₒᵤₜ, b*ₒᵤₜ are converted into tristimulus values Xₒᵤₜ, Yₒᵤₜ, Zₒᵤₜ according to Equation 19:

$$\begin{matrix}{Y}_{out} = ( f ( \frac{Y}{{Y}_{w}} ) - \frac{16}{116} ) \times \frac{1}{7.787} \times Yw & f ( \frac{Y}{{Y}_{w}} ) \leq 0.206893 \\ {Y}_{out} = {( f ( \frac{Y}{{Y}_{w}} ) )}^{3} \times Yw & 0.206893 < f ( \frac{Y}{{Y}_{w}} )\end{matrix} \qquad ( 19 )$$

Xₒᵤₜ and Zₒᵤₜ are calculated in a similar manner to Yₒᵤₜ. Here, f(X/X_{w}), f(Y/Y_{w}), f(Z/Z_{w}) are determined as in Equation 20:

$$f ( \frac{X}{{X}_{w}} ) = \frac{{a}^{*}}{500} + \frac{( {L}^{*} + 16 )}{116} \\ f ( \frac{Y}{{Y}_{w}} ) = \frac{( {L}^{*} + 16 )}{116} \\ f ( \frac{Z}{{Z}_{w}} ) = \frac{( {L}^{*} + 16 )}{116} - \frac{{b}^{*}}{200} \qquad ( 20 )$$

Further, Xₒᵤₜ, Yₒᵤₜ, Zₒᵤₜ are converted into output signals Rₒᵤₜ, Gₒᵤₜ, Bₒᵤₜ in RGB format as shown in Equation 21 according to the color reproduction range of the displaying unit, and the corrected image signal 109 is sent to the displaying unit 110.

$$[ \begin{matrix}{R}_{out} \\ {G}_{out} \\ {B}_{out}\end{matrix} ] = N [ \begin{matrix}{X}_{out} \\ {Y}_{out} \\ {Z}_{out}\end{matrix} ] \qquad ( 21 )$$

where “N” is a 3×3 matrix determined by the color reproduction range of the displaying unit.

Finally, the displaying unit 110 displays the output image signal 110 on the display screen (S206).

As described, in the present embodiment, when the user adjusts lightness, chroma, or hue, lightness and/or chroma of each hue is corrected so that the relative relationship of perceived brightnesses among the hues of the original image is maintained or so that the relative relationship is kept from varying. This enables natural image display that maintains perceived brightnesses among hues while achieving image quality adjustment desired by the user.

### Second Embodiment

### The User Adjusts Lightness, Chroma, or Hue of all Hues at One Time

A second embodiment will be described. The second embodiment is similar to the first embodiment in overall configuration and different in the adjusting unit. Thus, the adjusting unit will be described in detail.

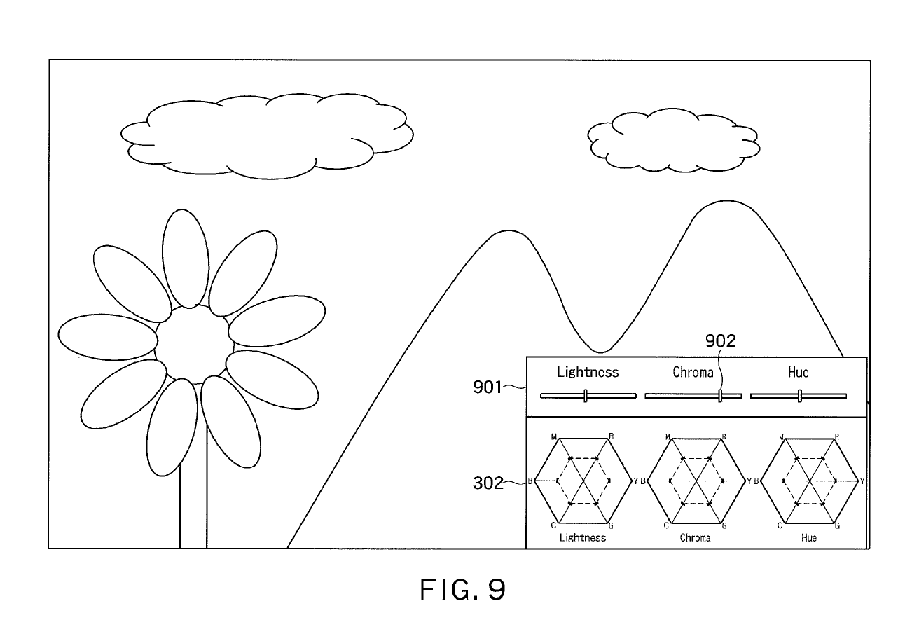

FIG. 9 depicts the display screen and the image quality adjustment screen shown on the displaying unit according to the second embodiment. The image quality adjustment screen in the second embodiment has an image quality adjustment screen 901 in which the lightness, chroma, or hue of all hues can be adjusted at one time, in addition to the image quality adjustment screen 302 of the first embodiment.

The second embodiment illustrates a case where the user increases the chroma of all hues at one time using the image quality adjustment screen 901. When the user moves a chroma slide bar 902 for controlling all hues together in increasing direction, the image quality adjusting unit 105 sends an amount of adjustment 106 indicating that the chroma of all hues has increased by the amount specified by the user, to the setting unit 104.

In response to it, the setting unit 104 determines a corrected converted signal in the case that the lightness, chroma, or hue in the converted signal 103 is corrected with the amount of adjustment 106 for all hues. Denoting the amount of chroma adjustment made by the user for all hues as ΔC*ᵢₙ, the corrected converted signal (L*ᵢₙ′, C*ᵢₙ′, hᵢₙ′) is determined from the converted signal (L*ᵢₙ, C*ᵢₙ, hᵢₙ) and the amount of adjustment ΔC*ᵢₙ as in Equation 22:

L*ᵢₙ′=L*ᵢₙ

C*ᵢₙ′=C*ᵢₙ+ΔC*ᵢₙ

hᵢₙ′=hᵢₙ (22)

The perceived brightness B*ᵢₙ(L*ᵢₙ, C*ᵢₙ, hᵢₙ) before correction with the amount of adjustment 106 in hue hᵢₙ and the perceived brightness after correction B*ᵢₙ′(L*ᵢₙ, C*ᵢₙ, hᵢₙ) are determined as in Equation 23:

$${B}_{in}^{*} ( {L}_{in}^{*} , {C}_{in}^{*} , {h}_{in} ) = {L}_{in}^{*} + ( F ( {h}_{in} ) + k ) \times {C}_{in}^{*} \\ \begin{matrix}{B}_{in}^{* ′} ( {L}_{in}^{*} , {C}_{in}^{*} , {h}_{in} ) = {L}_{in}^{* ′} + ( F ( {h}_{in}^{′} ) + k ) \times {C}_{in}^{* ′} \\ = {L}_{in}^{*} + ( F ( {h}_{in} ) + k ) \times ( {C}_{in}^{*} + Δ {C}_{in}^{*} )\end{matrix} \qquad ( 23 )$$

Further, the ratio P of perceived brightnesses before and after correction with the amount of adjustment 106 in each hue is calculated for each lightness and chroma value. The ratio of perceived brightness P(L*ᵢₙ, C*ᵢₙ, hᵢₙ) after the user adjustment with the lightness of L*ᵢₙ and chroma of C*ᵢₙ in hue hᵢₙ are calculated as in Equation 24:

$$\begin{matrix}P ( {L}_{in}^{*} , {C}_{in}^{*} , {h}_{in} ) = \frac{{B}_{in}^{* ′} ( {L}_{in}^{*} , {C}_{in}^{*} , {h}_{in} )}{{B}_{in}^{*} ( {L}_{in}^{*} , {C}_{in}^{*} , {h}_{in} )} \\ = \frac{{L}_{in}^{*} + ( F ( {h}_{in} ) + k ) \times ( {C}_{in}^{*} + Δ {C}_{in}^{*} )}{{L}_{in}^{*} + ( F ( {h}_{in} ) + k ) \times {C}_{in}^{*}}\end{matrix} \qquad ( 24 )$$

The Helmholtz-Kohlrausch effect acts to varying degrees depending on hue; for example, colors like red and magenta have a greater effect of appearing bright, while yellow and green have a smaller effect of appearing bright. Therefore, the ratio of perceived brightness P(L*ᵢₙ, C*ᵢₙ, hᵢₙ) assumes different values depending on hue hᵢₙ. Thus, as shown in Equation 25, the ratio of the hue that has the largest ratio P(L*ᵢₙ, C*ᵢₙ, hᵢₙ) of perceived brightnesses before and after correction with the amount of adjustment 106 among all hues is defined as the maximum value Pₘₐₓ(L*ᵢₙ,C*ᵢₙ) of the ratio of perceived brightness for all hues having equal lightness and chroma. Although the maximum value is employed in the illustrated case, the minimum value, or a representative value between the minimum and maximum values, such as a mean value or median, may be adopted.

Pₘₐₓ(L*ᵢₙ,C*ᵢₙ)=max{P(L*ᵢₙ,C*ᵢₙ,hᵢₙ)} (0≦hᵢₙ≦2π) (25)

The brightness B*ₒᵤₜ(L*ᵢₙ, C*ᵢₙ, hᵢₙ) perceived when the brightness B*ᵢₙ(L*ᵢₙ, C*ᵢₙ, hᵢₙ) perceived with the lightness L*ᵢₙ, chroma C*ᵢₙ, and hue hᵢₙ is multiplied by the ratio Pₘₐₓ(L*ᵢₙ, C*ᵢₙ) is calculated as shown in Equation 26, such that the relative relationship of perceived brightness among hues remains the same before and after the correction with the amount of adjustment 106.

B*ₒᵤₜ(L*ᵢₙ,C*ᵢₙ,hᵢₙ)=B*ᵢₙ(L*ᵢₙ,C*ᵢₙ,hᵢₙ)×Pₘₐₓ(L*ᵢₙ,C*ᵢₙ) (26)

The difference ΔB*ₒᵤₜ(L*ᵢₙ, C*ᵢₙ, hᵢₙ) between the perceived brightnesses B*ᵢₙ(L*ᵢₙ, C*ᵢₙ, hₘ) and B*ₒᵤₜ(L*ᵢₙ, C*ᵢₙ, hᵢₙ) is calculated as in Equation 27:

$$\begin{matrix}Δ {B}_{out}^{*} ( {L}_{in}^{*} , {C}_{in}^{*} , {h}_{in} ) = {B}_{out}^{*} ( {L}_{in}^{*} , {C}_{in}^{*} , {h}_{in} ) - {B}_{in}^{*} ( {L}_{in}^{*} , {C}_{in}^{*} , {h}_{in} ) \\ = \{ {P}_{max} ( {L}_{in}^{*} , {C}_{in}^{*} ) - 1 \} \times {B}_{in}^{*} ( {L}_{in}^{*} , {C}_{in}^{*} , {h}_{in} )\end{matrix} \qquad ( 27 )$$

Alternatively, ΔB*ₒᵤₜ(L*ᵢₙ, C*ᵢₙ, hᵢₙ) may be determined by calculating the difference of perceived brightness ΔB*ᵢₙ(L*ᵢₙ, C*ᵢₙ, hᵢₙ) before and after the correction with the amount of adjustment 106 according to Equation 28 and defining the maximum difference of perceived brightness ΔB*ᵢₙ(L*ᵢₙ, C*ᵢₙ, hᵢₙ) among all hues as ΔB*ₒᵤₜ(L*ᵢₙ, C*ᵢₙ, hᵢₙ) as shown by Equation 29. Although the maximum value is employed in the illustrated case, the minimum value, or a representative value between the minimum and maximum values, such as a mean value or median, may be adopted.

$$\begin{matrix}\begin{matrix}Δ {B}_{in}^{*} ( {L}_{in}^{*} , {C}_{in}^{*} , {h}_{in} ) = {B}_{in}^{* ′} ( {L}_{in}^{*} , {C}_{in}^{*} , {h}_{in} ) - {B}_{in}^{*} ( {L}_{in}^{*} , {C}_{in}^{*} , {h}_{in} ) \\ = ( F ( {h}_{in} ) + k ) \times Δ {C}_{in}^{*}\end{matrix} & ( 28 ) \\ Δ {B}_{out}^{*} ( {L}_{in}^{*} , {C}_{in}^{*} , {h}_{in} ) = max \{ Δ {B}_{in}^{*} ( {L}_{in}^{*} , {C}_{in}^{*} , {h}_{in} ) \} \\ ( 0 \leq {h}_{in} \leq 2 π ) & ( 29 )\end{matrix}$$

Further, as in the first embodiment, the amount of lightness correction ΔL*ₒᵤₜ and the amount of chroma correction ΔC*ₒᵤₜ are set as the amount of correction 107 based on the difference of perceived brightness ΔB*ₒᵤₜ(L*ᵢₙ, C*ᵢₙ, hᵢₙ), and the amount of correction 107 is sent to the adjusting unit 105 and the correcting unit 108. The adjusting unit 105 automatically changes the indication of amount of adjustment on the adjustment screen 302 in accordance with the amount of correction 107. The correcting unit 108 corrects the converted signal 103 in accordance with the amount of correction 107 to obtain the corrected image signal 109, and sends it to the displaying unit 110. The displaying unit 110 displays the corrected image signal 109 on the display screen.

As described, in the present embodiment, when the user adjusts lightness, chroma, or hue, lightness and/or chroma of each hue is corrected so that the relative relationship of perceived brightness among hues of the original image is maintained or so that the relative relationship is kept from varying. This enables image display that maintains perceived brightnesses among hues while achieving image quality adjustment desired by the user.

### Third Embodiment

### The User Adjusts Image Quality Specifying a Given Point on Screen

A third embodiment will be now described. The third embodiment is similar to the second embodiment in overall configuration and different in the adjusting unit. Thus, the adjusting unit will be described in detail.

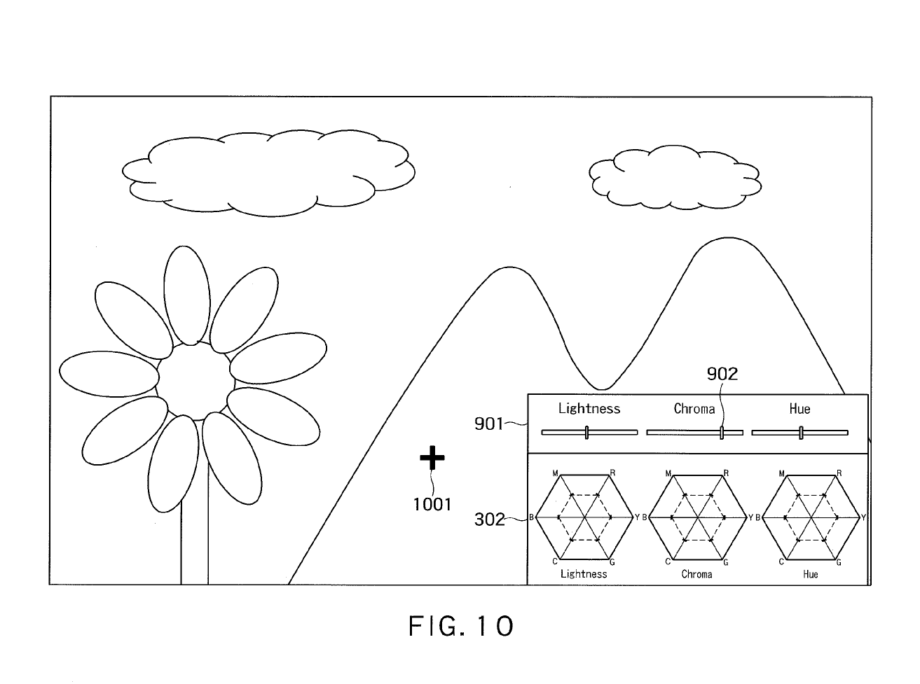

FIG. 10 depicts an image and an image quality adjustment screen shown on the displaying unit according to the third embodiment. The image quality adjustment screen in the third embodiment includes a pointer 1001 with which the user can specify a pixel on the screen, in addition to the image quality adjustment screens 302 and 901. The third embodiment allows the user to specify a pixel in which the user wants to make an image quality adjustment using the pointer 1001. Subsequently, the lightness, chroma, or hue of the pixel specified by the user is adjusted using the image quality adjustment screen 901.

The third embodiment illustrates a case where the user increases chroma by ΔC*ᵢₙ in the screen 901 for a pixel specified with the pointer 1001. When the user moves the chroma slide bar 902 in increasing direction, the image quality adjusting unit 105 sends an amount of adjustment 106 indicating that the chroma of the hue exhibited by the pixel indicated by the pointer 1001 has increased by the amount specified by the user, to the setting unit 104.

When the hue of the pixel specified by the user with the pointer 1001 is hₚ, the setting unit 104 converts a converted signal with the lightness L*ᵢₙ, chroma C*ᵢₙ, and hue hₚ into a corrected converted signal (L*ᵢₙ′, C*ᵢₙ′, hₚ′) according to the amount of adjustment 106 as in Equation 30:

L*ᵢₙ′=L*ᵢₙ

C*ᵢₙ′=C*ᵢₙ+ΔC*ᵢₙ

hₚ′=hₚ (30)

The setting unit 104 further calculates perceived brightness for each of the converted signal (L*ᵢₙ, C*ᵢₙ, hₚ) and the corrected converted signal (L*ᵢₙ′, hₚ′). The perceived brightness B*ᵢₙ(L*ᵢₙ, C*ᵢₙ, hₚ) before adjustment of the hue hₚ exhibited by the pixel specified by the user with the pointer 1001 and the perceived brightness after adjustment B*ᵢₙ′(L*ᵢₙ, C*ᵢₙ, hₚ) are calculated as in Equation 31:

$${B}_{in}^{*} ( {L}_{in}^{*} , {C}_{in}^{*} , {h}_{p} ) = {L}_{in}^{*} + ( F ( {h}_{p} ) + k ) \times {C}_{in}^{*} \\ \begin{matrix}{B}_{in}^{* ′} ( {L}_{in}^{*} , {C}_{in}^{*} , {h}_{p} ) = {L}_{in}^{* ′} + ( F ( {h}_{p}^{′} ) + k ) \times {C}_{in}^{* ′} \\ = {L}_{in}^{*} + ( F ( {h}_{p} ) + k ) \times ( {C}_{in}^{*} + Δ {C}_{in}^{*} )\end{matrix} \qquad ( 31 )$$

Further, the ratio P of perceived brightnesses before and after the adjustment of the hue exhibited by the pixel specified by the user with the pointer 1001 is calculated for each of lightness and chroma values. The ratio of perceived brightness P(L*ᵢₙ, C*ᵢₙ, hₚ) after the user adjustment with the lightness L*ᵢₙ and chroma C*ᵢₙ is calculated as in Equation 32:

$$\begin{matrix}P ( {L}_{in}^{*} , {C}_{in}^{*} , {h}_{p} ) = \frac{{B}_{in}^{* ′} ( {L}_{in}^{*} , {C}_{in}^{*} , {h}_{p} )}{{B}_{in}^{*} ( {L}_{in}^{*} , {C}_{in}^{*} , {h}_{p} )} \\ = \frac{{L}_{in}^{*} + ( F ( {h}_{p} ) + k ) \times ( {C}_{in}^{*} + Δ {C}_{in}^{*} )}{{L}_{in}^{*} + ( F ( {h}_{p} ) + k ) \times {C}_{in}^{*}}\end{matrix} \qquad ( 32 )$$

Further, as shown in Equation 33, the ratio of perceived brightness P(L*ᵢₙ, C*ᵢₙ, hₚ) before and after the adjustment of the hue hₚ exhibited by the pixel specified by the user with the pointer 1001 is defined as the ratio to be applied in common to all hues that have equal lightness and chroma. Thus, this ratio is defined as Pₘₐₓ(L*ᵢₙ, C*ᵢₙ)

Pₘₐₓ(L*ᵢₙ,C*ᵢₙ)=P(L*ᵢₙ,C*ᵢₙ,hₚ) (33)

Since the perceived brightness of the pixel specified by the user with the pointer 1001 has increased by the ratio Pₘₐₓ(L*ᵢₙ, C*ᵢₙ) as a result of the user adjustment, by multiplying the perceived brightness of the other colors by the ratio Pₘₐₓ(L*ᵢₙ, C*ᵢₙ), the ratio of perceived brightness among all hues that have equal lightness and chroma can be kept the same as before the user adjustment.

The brightness B*ₒᵤₜ(L*ᵢₙ, C*ᵢₙ, hᵢₙ) perceived when the perceived brightness B*ᵢₙ(L*ᵢₙ, C*ᵢₙ, hᵢₙ) with the lightness of L*ᵢₙ and chroma of C*ᵢₙ in hue hᵢₙ is multiplied by ratio Pₘₐₓ(L*ᵢₙ, C*ᵢₙ) is calculated as in Equation 34:

B*ₒᵤₜ(L*ᵢₙ,C*ᵢₙ,hᵢₙ)=B*ᵢₙ(L*ᵢₙ,C*ᵢₙ,hᵢₙ)×Pₘₐₓ(L*ᵢₙ,C*ᵢₙ) (34)

Further, the difference ΔB*ₒᵤₜ(L*ᵢₙ, C*ᵢₙ, hᵢₙ) between the perceived brightnesses B*ᵢₙ(L*ᵢₙ, C*ᵢₙ, hᵢₙ) and B*ₒᵤₜ(L*ᵢₙ, C*ᵢₙ, hᵢₙ) is calculated according to Equation 35:

$$\begin{matrix}Δ {B}_{out}^{*} ( {L}_{in}^{*} , {C}_{in}^{*} , {h}_{in} ) = {B}_{out}^{*} ( {L}_{in}^{*} , {C}_{in}^{*} , {h}_{in} ) - {B}_{in}^{*} ( {L}_{in}^{*} , {C}_{in}^{*} , {h}_{in} ) \\ = \{ {P}_{max} ( {L}_{in}^{*} , {C}_{in}^{*} ) - 1 \} \times {B}_{in}^{*} ( {L}_{ni}^{*} , {C}_{in}^{*} , {h}_{in} )\end{matrix} \qquad ( 35 )$$

Alternatively, ΔB*ₒᵤₜ(L*ᵢₙ, C*ᵢₙ, hᵢₙ) may be set as the difference in perceived brightness in the hue hₚ of the pixel specified by the user with the pointer 1001, as shown in Equation 36:

$$\begin{matrix}Δ {B}_{out}^{*} ( {L}_{i n}^{*} , {C}_{i n}^{*} , {H}_{i n} ) = {B}_{i n}^{* ′} ( {L}_{i n}^{*} , {C}_{i n}^{*} , {h}_{p} ) - {B}_{i n}^{*} ( {L}_{i n}^{*} , {C}_{i n}^{*} , {h}_{p} ) \\ = ( F ( {h}_{p} ) + k ) \times Δ {C}_{i n}^{*}\end{matrix} \qquad ( 36 )$$

Further, as in the first embodiment, the amount of lightness correction ΔL*ₒᵤₜ and the amount of chroma correction ΔC*ₒᵤₜ are set as the amount of correction 107 from the difference of perceived brightness ΔB*ₒᵤₜ(L*ᵢₙ, C*ᵢₙ, hᵢₙ), and the amount of correction 107 is sent to the adjusting unit 105 and the correcting unit 108. The adjusting unit 105 automatically changes the indication of amount of adjustment on the adjustment screen 302 in accordance with the amount of correction 107. The correcting unit 108 corrects the converted signal 103 in accordance with the amount of correction 107 to obtain the corrected image signal 109, and sends it to the displaying unit 110. The displaying unit 110 displays the corrected image signal 109 on the display screen.

As described, in the present embodiment, when the user adjusts lightness, chroma, or hue, lightness and/or chroma of each hue is corrected so that the relative relationship of perceived brightnesses among the hues of the original image is maintained or so that the relative relationship is kept from varying. This enables image display that maintains perceived brightnesses among hues while achieving image quality adjustment desired by the user.

### Fourth Embodiment

### The User Adjusts the Perceived Brightness Per Hue

A fourth embodiment will be described. The fourth embodiment is similar to the first embodiment in overall configuration and different in the adjusting unit. Thus, the adjusting unit will be described in detail.

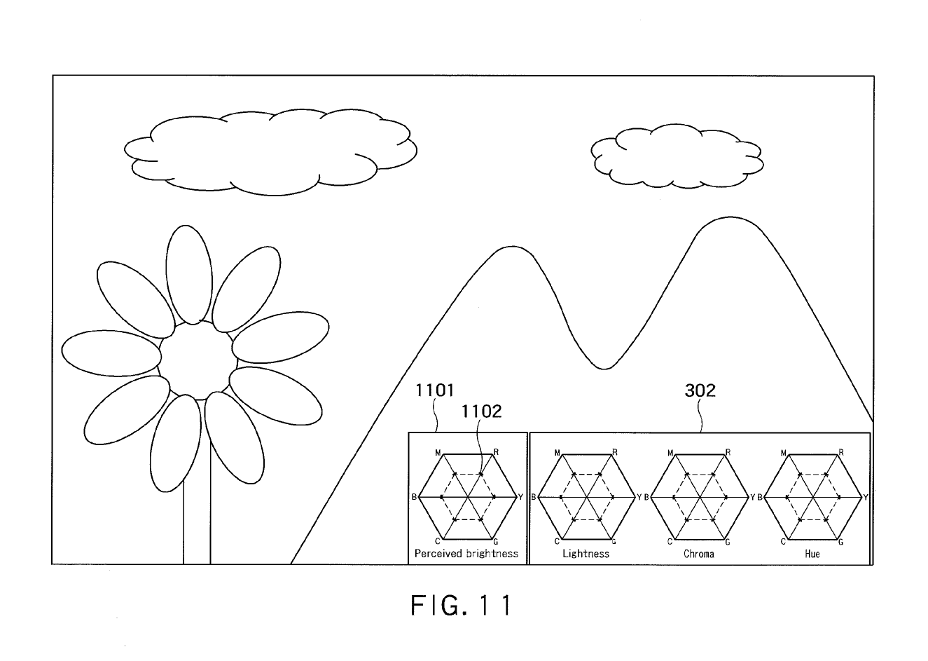

FIG. 11 depicts an image and the image quality adjustment screen shown on the displaying unit according to the fourth embodiment. The image quality adjustment screen in the fourth embodiment includes an image quality adjustment screen 1101 in which the perceived brightness of each hue can be adjusted, in addition to the image quality adjustment screen 302 of the first embodiment. In the adjustment screen 1101 shown in FIG. 11, the user can adjust the perceived brightness in a desired hue.

The fourth embodiment illustrates a case where the user increases the perceived brightness in the red hue by ΔB*ᵢₙ in the image quality adjustment screen 1101. When the user moves a slide bar 1102 for the perceived brightness of the red hue in increasing direction, the image quality adjusting unit 105 sends an amount of adjustment 106 indicating that the perceived brightness of the red hue has increased by ΔB*ᵢₙ to the setting unit 104. The perceived brightnesses before and after the user's adjustment in terms of lightness L*ᵢₙ and chroma C*ᵢₙ in the red hue are respectively represented as in Equation 37:

B*ᵢₙ(L*ᵢₙ,C*ᵢₙ,hᵢₙ(R))=L*ᵢₙ+(F(hᵢₙ(R))+k)×C*ᵢₙ

B*ᵢₙ′(L*ᵢₙ,C*ᵢₙ,hᵢₙ(R))=L*ᵢₙ+(F(hᵢₙ(R))+k)×C*ᵢₙ+ΔB*ᵢₙ (37)

Further, the ratio P of perceived brightnesses before and after the adjustment of the hue hᵢₙ(R) by the user is calculated for each of lightness and chroma values. The ratio of perceived brightness P(L*ᵢₙ, C*ᵢₙ, hᵢₙ(R)) after the user adjustment with the lightness of L*ᵢₙ and chroma of C*ᵢₙ in hue hᵢₙ(R) are calculated as in Equation 38:

$$\begin{matrix}P ( {L}_{i n}^{*} , {C}_{i n}^{*} , {h}_{i n} ( R ) ) = \frac{{B}_{i n}^{* ′} ( {L}_{i n}^{*} , {C}_{i n}^{*} , {h}_{i n} ( R ) )}{{B}_{i n}^{*} ( {L}_{i n}^{*} , {C}_{i n}^{*} , {h}_{i n} ( R ) )} \\ = \frac{{L}_{i n}^{*} + ( F ( {h}_{i n} ( R ) ) + k ) \times {C}_{i n}^{*} + Δ {B}_{i n}^{*}}{{L}_{i n}^{*} + ( F ( {h}_{i n} ( R ) ) + k ) \times {C}_{i n}^{*}}\end{matrix} \qquad ( 38 )$$

Further, as shown in Equation 39, the ratio of perceived brightness P(L*ᵢₙ, C*ᵢₙ, hᵢₙ(R)) before and after the adjustment of the hue hᵢₙ(R) adjusted by the user is defined as the ratio for application in common to all hues that have equal lightness and chroma. Thus, the ratio is defined as Pₘₐₓ(L*ᵢₙ, C*ᵢₙ):

Pₘₐₓ(L*ᵢₙ,C*ᵢₙ)=P(L*ᵢₙ,C*ᵢₙ,hᵢₙ(R)) (39)

The perceived brightness of the hue hᵢₙ(R) has increased by the ratio Pₘₐₓ(L*ᵢₙ, C*ᵢₙ) as a result of the user adjustment. Thus, by multiplying the perceived brightness of the other hues for which the user does not adjust image quality by the ratio Pₘₐₓ(L*ᵢₙ, C*ᵢₙ) as shown in Equation 40, the ratio of perceived brightness among all hues having equal lightness and chroma can be kept the same as the ratio before the user adjustment.

The brightness B*ₒᵤₜ (L*ᵢₙ, C*ᵢₙ, hᵢₙ) perceived when the perceived brightness B*ᵢₙ(L*ᵢₙ, C*ᵢₙ, hᵢₙ) with the lightness L*ᵢₙ and chroma C*ᵢₙ in hue hᵢₙ is multiplied by ratio Pₘₐₓ(L*ᵢₙ, C*ᵢₙ) is calculated as in Equation 40:

B*ₒᵤₜ(L*ᵢₙ,C*ᵢₙ,hᵢₙ)=B*ᵢₙ(L*ᵢₙ,C*ᵢₙ,hᵢₙ)×Pₘₐₓ(L*ᵢₙ,C*ᵢₙ) (40)

Further, the difference ΔB*ₒᵤₜ(L*ᵢₙ, C*ᵢₙ, hᵢₙ) between the perceived brightnesses B*ᵢₙ(L*ᵢₙ, C*ᵢₙ, hᵢₙ) and B*ₒᵤₜ(L*ᵢₙ, C*ᵢₙ, hᵢₙ) is calculated according to Equation 41:

$$\begin{matrix}Δ {B}_{out}^{*} ( {L}_{i n}^{*} , {C}_{i n}^{*} , {h}_{i n} ) = {B}_{out}^{*} ( {L}_{i n}^{*} , {C}_{i n}^{*} , {h}_{i n} ) - {B}_{i n}^{*} ( {L}_{i n}^{*} , {C}_{i n}^{*} , {h}_{i n} ) \\ = \{ {P}_{max} ( {L}_{i n}^{*} , {C}_{i n}^{*} ) - 1 \} \times {B}_{i n}^{*} ( {L}_{i n}^{*} , {C}_{i n}^{*} , {h}_{i n} )\end{matrix} \qquad ( 41 )$$

Alternatively, the difference in perceived brightness ΔB*ₒᵤₜ(L*ᵢₙ, C*ᵢₙ, hᵢₙ) may be set as the difference in perceived brightness in the hue hᵢₙ(R) adjusted by the user, as shown in Equation 42:

ΔB*ₒᵤₜ(L*ᵢₙ,C*ᵢₙ,hᵢₙ)=ΔB*ᵢₙ (42)

Further, as in the first embodiment, the amount of lightness correction ΔL*ₒᵤₜ and the amount of chroma correction ΔC*ₒᵤₜ are set as the amount of correction 107 from the difference of perceived brightness ΔB*ₒᵤₜ(L*ᵢₙ, C*ᵢₙ, hᵢₙ), and the amount of correction 107 is sent to the adjusting unit 105 and the correcting unit 108. The adjusting unit 105 automatically changes the indication of amount of adjustment on the adjustment screen 302 in accordance with the amount of correction 107. The correcting unit 108 corrects the converted signal 103 in accordance with the amount of correction 107 to obtain the corrected image signal 109, and sends it to the displaying unit 110. The displaying unit 110 displays the corrected image signal 109 on the display screen.

As described, in the present embodiment, when the user adjusts the perceived brightness, lightness and/or chroma of each hue is corrected so that the relative relationship of perceived brightnesses between different hues of the original image is maintained or so that the relative relationship is kept from varying. This enables image display that maintains perceived brightnesses among hues while achieving image quality adjustment desired by the user.

### Fifth Embodiment

### The Perceived Brightness is Adjusted for all Hues at One Time

A fifth embodiment will be described. The fifth embodiment is similar to the fourth embodiment in overall configuration and different in the adjusting unit. Thus, the adjusting unit will be described in detail.

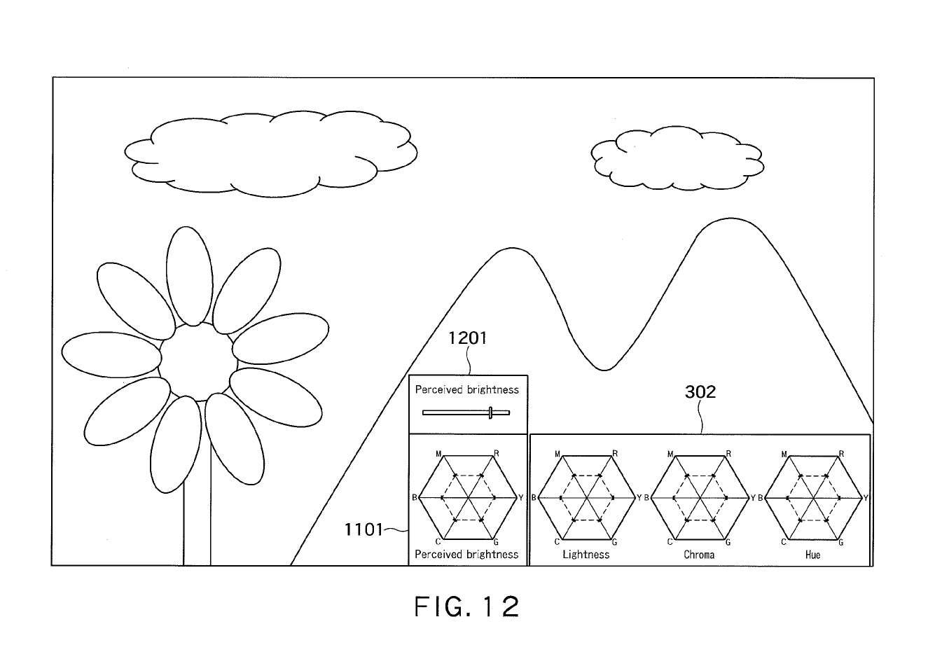

FIG. 12 depicts an image and an image quality adjustment screen shown on the displaying unit according to the fifth embodiment. The image quality adjustment screen in the fifth embodiment includes an image quality adjustment screen 1201 in which the perceived brightness of all hues can be adjusted at one time, in addition to the image quality adjustment screens 302 and 1101 of the fourth embodiment.

The fifth embodiment illustrates a case where the user increase the perceived brightness by ΔB*ᵢₙ of all hues at one time in the image quality adjustment screen 1201. When the user moves a slide bar 1102 for controlling the perceived brightness of all hues together in increasing direction, the image quality adjusting unit 105 sends an amount of adjustment 106 indicating that the perceived brightness of all hues has increased by ΔB*ᵢₙ to the setting unit 104.

The perceived brightnesses before and after the user adjustment in terms of lightness L*ᵢₙ and chroma C*ᵢₙ in hue hᵢₙ are respectively represented as in Equation 43:

B*ᵢₙ(L*ᵢₙ,C*ᵢₙ,hᵢₙ)=L*ᵢₙ+(F(hᵢₙ)+k)×C*ᵢₙ

B*ᵢₙ′(L*ᵢₙ,C*ᵢₙ,hᵢₙ)=L*ᵢₙ+(F(hᵢₙ)+k)×C*ᵢₙ+ΔB*ᵢₙ (43)

Further, the ratio P of perceived brightnesses of all hues before and after the adjustment is calculated for each of lightness and chroma values. The ratio of perceived brightness P(L*ᵢₙ, C*ᵢₙ, hᵢₙ) after the user adjustment with the lightness of L*ᵢₙ and chroma of C*ᵢₙ in hue hᵢₙ is calculated as in Equation 44:

$$\begin{matrix}P ( {L}_{i n}^{*} , {C}_{i n}^{*} , {h}_{i n} ) = \frac{{B}_{i n}^{* ′} ( {L}_{i n}^{*} , {C}_{i n}^{*} , {h}_{i n} )}{{B}_{i n}^{*} ( {L}_{i n}^{*} , {C}_{i n}^{*} , {h}_{i n} )} \\ = \frac{{L}_{i n}^{*} + ( F ( {h}_{i n} ) + k ) \times {C}_{i n}^{*} + Δ {B}_{i n}^{*}}{{L}_{i n}^{*} + ( F ( {h}_{i n} ) + k ) \times {C}_{i n}^{*}}\end{matrix} \qquad ( 44 )$$

Further, as shown in Equation 45, the ratio of the hue that has the largest ratio P(L*ᵢₙ, C*ᵢₙ, hᵢₙ) of perceived brightnesses before and after correction of all hues among all hues is defined as the maximum value Pₘₐₓ(L*ᵢₙ,C*ᵢₙ) of the ratio of perceived brightness for all hues having equal lightness and chroma. Although the maximum value is employed in the illustrated case, the minimum value, or a representative value between the minimum and maximum values, such as a mean value or median, may be adopted.

Pₘₐₓ(L*ᵢₙ,C*ᵢₙ)=max{P(L*ᵢₙ,C*ᵢₙ,hᵢₙ)} (0≦hᵢₙ≦2π) (45)

The Helmholtz-Kohlrausch effect acts to varying degrees depending on hue; for example, colors like red and magenta have a greater effect of appearing bright, while yellow and green have a smaller effect of appearing bright. Therefore, the ratio of perceived brightness P(L*ᵢₙ, C*ᵢₙ, hᵢₙ) assumes different values depending on hue hᵢₙ, and the maximum ratio among all hues is defined as Pₘₐₓ(L*ᵢₙ, C*ᵢₙ) The brightness B*ₒᵤₜ(L*ᵢₙ, C*ᵢₙ, hᵢₙ) perceived when the brightness B*ᵢₙ(L*ᵢₙ, C*ᵢₙ, hᵢₙ) perceived with the lightness L*ᵢₙ, chroma C*ᵢₙ in hue hᵢₙ is multiplied by the ratio Pₘₐₓ(L*ᵢₙ, C*ᵢₙ) is calculated as shown in Equation 46:

B*ₒᵤₜ(L*ᵢₙ,C*ᵢₙ,hᵢₙ)=B*ᵢₙ(L*ᵢₙ,C*ᵢₙ,hᵢₙ)×Pₘₐₓ(L*ᵢₙ,C*ᵢₙ) (46)

Further, the difference ΔB*ₒᵤₜ(L*ᵢₙ, C*ᵢₙ, hᵢₙ) between perceived brightnesses B*ᵢₙ(L*ᵢₙ, C*ᵢₙ, hᵢₙ) and B*ₒᵤₜ(L*ᵢₙ, C*ᵢₙ, hᵢₙ) is calculated as in Equation 47:

$$\begin{matrix}Δ {B}_{out}^{*} ( {L}_{i n}^{*} , {C}_{i n}^{*} , {h}_{i n} ) = {B}_{out}^{*} ( {L}_{i n}^{*} , {C}_{i n}^{*} , {h}_{i n} ) - {B}_{i n}^{*} ( {L}_{i n}^{*} , {C}_{i n}^{*} , {h}_{i n} ) \\ = \{ {P}_{max} ( {L}_{i n}^{*} , {C}_{i n}^{*} ) - 1 \} \times {B}_{i n}^{*} ( {L}_{i n}^{*} , {C}_{i n}^{*} , {h}_{i n} )\end{matrix} \qquad ( 47 )$$

Alternatively, the difference of perceived brightness ΔB*ₒᵤₜ(L*ᵢₙ, C*ᵢₙ, hᵢₙ) may be set to the amount of adjustment of perceived brightness ΔB*₁ₙ.

Further, as in the first embodiment, the amount of lightness correction ΔL*ₒᵤₜ and the amount of chroma correction ΔC*ₙᵤₜ are set as the amount of correction 107 from the difference of perceived brightness ΔB*ₒᵤₜ(L*ᵢₙ, C*ᵢₙ, hᵢₙ), and the amount of correction 107 is sent to the adjusting unit 105 and the correcting unit 108. The adjusting unit 105 automatically changes the indication of amount of adjustment on the adjustment screen 302 in accordance with the amount of correction 107. The correcting unit 108 corrects the converted signal 103 in accordance with the amount of correction 107 to obtain the corrected image signal 109, and sends it to the displaying unit 110. The displaying unit 110 displays the corrected image signal 109 on the display screen.

As described, in the present embodiment, when the user adjusts the perceived brightness, lightness and/or chroma of each hue is corrected so that the relative relationship of perceived brightnesses among the hues of the original image is maintained or so that the relative relationship is kept from varying. This enables image display that maintains perceived brightnesses among hues while achieving image quality adjustment desired by the user.

### Sixth Embodiment

### The User Specifies a Pixel and Perceived Brightness

A sixth embodiment will be described. The sixth embodiment is similar to the fifth embodiment in overall configuration and different in the adjusting unit. Thus, the adjusting unit will be described in detail.

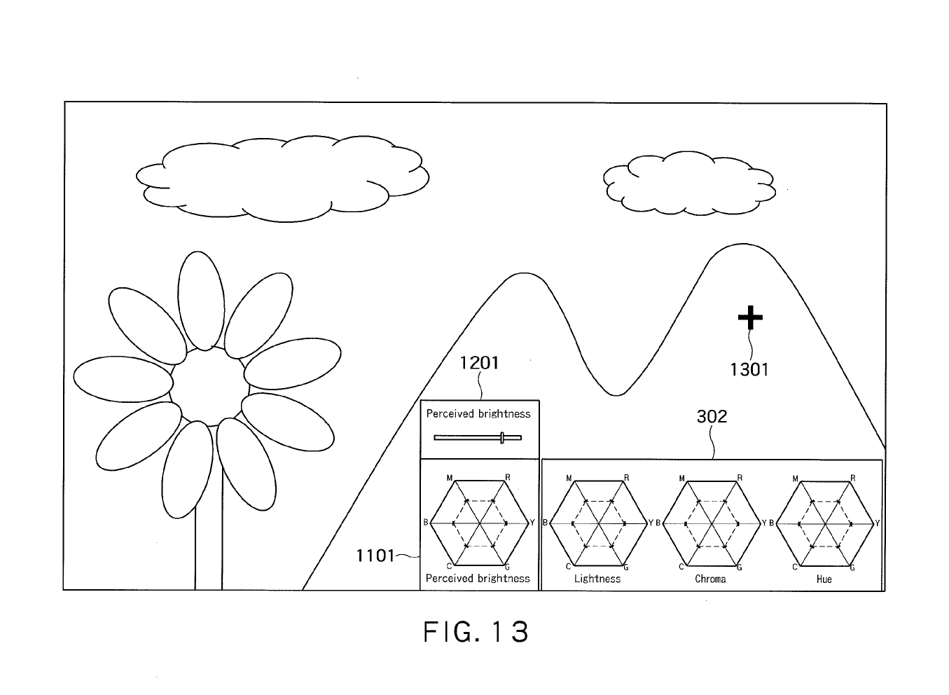

FIG. 13 depicts an image and the image quality adjustment screen shown on the displaying unit according to the sixth embodiment. The image quality adjustment screen in the sixth embodiment includes a pointer 1301 with which the user can specify a pixel on the screen, in addition to the image quality adjustment screens 302, 1101, and 1201. The sixth embodiment allows the user to specify a pixel in which the user wants to make an image quality adjustment using the pointer 1301. The user then adjusts the perceived brightness of the pixel the user specified using the image quality adjustment screen 1201.

The sixth embodiment illustrates a case where the user increases the perceived brightness of the pixel specified with the pointer 1301 by ΔB*ᵢₙ in the screen 1201. When the user moves the brightness slide bar in increasing direction, the image quality adjusting unit 105 sends an amount of adjustment 106 indicating that the brightness of the hue exhibited by the pixel indicated by the pointer 1301 has increased by ΔB*ᵢₙ to the setting unit 104.

When the hue of the pixel specified by the user with the pointer 1301 is hₚ, the setting unit 104 calculates the perceived brightness B*ᵢₙ before adjustment and the perceived brightness after adjustment B*ᵢₙ′ of the converted signal with lightness L*ᵢₙ, chroma C*ᵢₙ, and hue hₚ, as in Equation 48:

B*ᵢₙ(L*ᵢₙ,C*ᵢₙ,hₚ)=L*ᵢₙ+(F(hₚ)+k)×C*ᵢₙ

B*ᵢₙ′(L*ᵢₙ,C*ᵢₙ,hₚ)=L*ᵢₙ′+(F(hₚ′)+k)×C*ᵢₙ+ΔB*ᵢₙ (48)

Further, the ratio P of perceived brightnesses before and after the adjustment of hue hₚ represented by the pixel specified by the user with the pointer 1301 is calculated for each of lightness and chroma values. The ratio of perceived brightness P(L*ᵢₙ, C*ᵢₙ, hₚ) after the user adjustment with the lightness of L*ᵢₙ and chroma of C*ᵢₙ is calculated as in Equation 49:

$$\begin{matrix}P ( {L}_{i n}^{*} , {C}_{i n}^{*} , {h}_{p} ) = \frac{{B}_{i n}^{* ′} ( {L}_{i n}^{*} , {C}_{i n}^{*} , {h}_{p} )}{{B}_{i n}^{*} ( {L}_{i n}^{*} , {C}_{i n}^{*} , {h}_{p} )} \\ = \frac{{L}_{i n}^{*} + ( F ( {h}_{p} ) + k ) \times {C}_{i n}^{*} + Δ {B}_{i n}^{*}}{{L}_{i n}^{*} + ( F ( {h}_{p} ) + k ) \times {C}_{i n}^{*}}\end{matrix} \qquad ( 49 )$$

Further, as shown in Equation 50, the ratio of perceived brightness P(L*ᵢₙ, C*ᵢₙ, hₚ) before and after the adjustment of the hue hₚ of the pixel specified by the user with the pointer 1301 is defined as the ratio for application in common to all hues that have equal lightness and chroma. Thus, this ratio is defined as Pₘₐₓ(L*ᵢₙ, C*ᵢₙ).

Pₘₐₓ(L*ᵢₙ,C*ᵢₙ)=P(L*ᵢₙ,C*ᵢₙ,hₚ) (50)

Since the perceived brightness of the pixel specified by the user with the pointer 1301 has increased by the ratio Pₘₐₓ(L*ᵢₙ, C*₁ₙ) as a result of the user adjustment, by multiplying the perceived brightness of the other hues by the ratio Pₘₐₓ(L*ᵢₙ, C*ᵢₙ), the ratio of perceived brightness among all hues having equal lightness and chroma can be kept the same as the ratio before the user performed adjustment.

The brightness B*ₒᵤₜ(L*ᵢₙ, C*ᵢₙ, hᵢₙ) perceived when the perceived brightness B*ᵢₙ(L*ᵢₙ, C*ᵢₙ, hᵢₙ) with the lightness of L*ᵢₙ and chroma of C*ᵢₙ in hue hᵢₙ is multiplied by ratio Pₘₐₓ(L*ᵢₙ, C*ᵢₙ) is calculated as in Equation 51:

B*ₒᵤₜ(L*ᵢₙ,C*ᵢₙ,hᵢₙ)=B*ᵢₙ(L*ᵢₙ,C*ᵢₙ,hᵢₙ)×Pₘₐₓ(L*ᵢₙ,C*ᵢₙ) (51)

Further, the difference ΔB*ₒᵤₜ(L*ᵢₙ, C*ᵢₙ, hᵢₙ) between the perceived brightnesses B*ᵢₙ(L*ᵢₙ, C*ᵢₙ, hᵢₙ) and B*ₒᵤₜ(L*ᵢₙ, C*ᵢₙ, hᵢₙ) is calculated according to Equation 52:

$$\begin{matrix}Δ {B}_{out}^{*} ( {L}_{i n}^{*} , {C}_{i n}^{*} , {h}_{i n} ) = {B}_{out}^{*} ( {L}_{i n}^{*} , {C}_{i n}^{*} , {h}_{i n} ) - {B}_{i n}^{*} ( {L}_{i n}^{*} , {C}_{i n}^{*} , {h}_{i n} ) \\ = \{ {P}_{max} ( {L}_{i n}^{*} , {C}_{i n}^{*} ) - 1 \} \times {B}_{i n}^{*} ( {L}_{i n}^{*} , {C}_{i n}^{*} , {h}_{i n} )\end{matrix} \qquad ( 52 )$$

Alternatively, the difference of perceived brightness ΔB*ₒᵤₜ(L*ᵢₙ, C*ᵢₙ, hᵢₙ) may be set as the difference in perceived brightness ΔB*ᵢₙ of the pixel specified by the user with the pointer 1301, as shown in Equation 53:

ΔB*ₒᵤₜ(L*ᵢₙ,C*ᵢₙ,hᵢₙ)=ΔB*ᵢₙ (53)

Further, as in the first embodiment, the amount of lightness correction ΔL*ₒᵤₜ and the amount of chroma correction ΔC*ₒᵤₜ are set as the amount of correction 107 from the difference of perceived brightness ΔB*ₒᵤₜ(L*ᵢₙ, C*ᵢₙ, hᵢₙ), and the amount of correction 107 is sent to the adjusting unit 105 and the correcting unit 108. The adjusting unit 105 automatically changes the indication of amount of adjustment on the adjustment screen 302 in accordance with the amount of correction 107. The correcting unit 108 corrects the converted signal 103 in accordance with the amount of correction 107 to obtain the corrected image signal 109, and sends it to the displaying unit 110. The displaying unit 110 displays the corrected image signal 109 on the display screen.

As described, in the present embodiment, when the user adjusts perceived brightness, lightness and/or chroma of each hue is corrected so that the relative relationship of perceived brightnesses among the hues of the original image is maintained or so that the relative relationship is kept from varying. This enables image display with perceived brightnesses among hues maintained while achieving image quality adjustment desired by the user.

### Seventh Embodiment

### When the Reference Color Gamut is Different from the Panel Color Gamut

A seventh embodiment will be described. As the seventh embodiment is similar to the first embodiment in overall configuration, differences from the first embodiment will be described in detail.

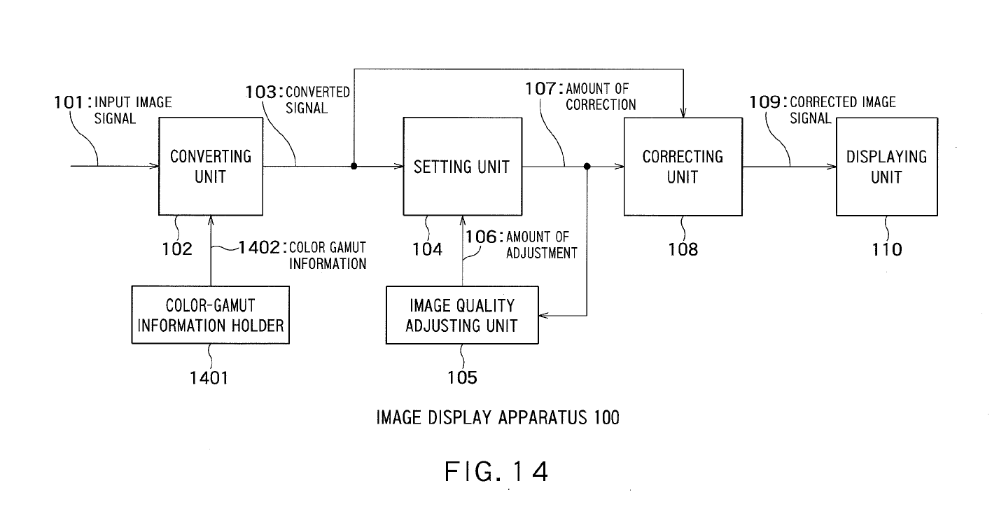

FIG. 14 shows the configuration of the image display apparatus in the seventh embodiment. The seventh embodiment includes a color-gamut information holder 1401 in addition to the components of the first embodiment. In the seventh embodiment, a standardized color reproduction range such as ITU-R BT.709 is used as the reference color reproduction range, and the chroma or lightness of each hue is corrected so that the relative relationship of perceived brightness among hues in the reference color reproduction range is maintained when displayed on the image displaying unit. The seventh embodiment illustrates a case where the color reproduction range defined by ITU-R BT.709 is used as the reference color reproduction range.

The converting unit 102 receives color gamut information of BT.709, which is the reference color reproduction range, from the color-gamut information holder, and determines tristimulus values (X₇₀₉, Y₇₀₉, Z₇₀₉) converted according to the color reproduction range defined by BT.709 and tristimulus values (X_{d}, Y_{d}, Z_{d}) converted according to the color reproduction range of the image displaying unit from the input image signal 101, according to Equation 54:

$$[ \begin{matrix}{X}_{d} \\ {Y}_{d} \\ {Z}_{d}\end{matrix} ] = M [ \begin{matrix}{R}_{i n} \\ {G}_{i n} \\ {B}_{i n}\end{matrix} ] \\ [ \begin{matrix}{X}_{709} \\ {Y}_{709} \\ {Z}_{709}\end{matrix} ] = L [ \begin{matrix}{R}_{i n} \\ {G}_{i n} \\ {B}_{i n}\end{matrix} ] \qquad ( 54 )$$

In the equation, “M” represents a 3×3 color conversion matrix depending on the color reproduction range of the image displaying unit, and “L” represents a 3×3 color conversion matrix depending on the color reproduction range defined by ITU-R BT.709. “L” is maintained in the color-gamut information holder 1401. “M” is maintained in the converting unit 102 or a storage accessible to the converting unit 102.

The converting unit further calculates the lightnesses, chromas, and hues in CIEL*a*b* space (L*₇₀₉, C*₇₀₉, h₇₀₉) and (L*_{d}, C*_{d}, h_{d}) respectively from (X₇₀₉, Y₇₀₉, Z₇₀₉) and (X_{d}, Y_{d}, Z_{d}). As conversion from XYZ tristimulus values to the lightness, chroma, and hue in CIEL*a*b* space is similar to the first embodiment, description of how to calculate them is omitted.

The image quality adjusting unit 105 can adjust the amount of adjustment of lightness, chroma, or hue on a per-hue basis as in the first embodiment, and sends the amount of adjustment 106 made by the user to the setting unit 104. The seventh embodiment illustrates a case where the user adjusts the chroma of the red hue by ΔC*ᵢₙ.

First, the setting unit 104 calculates the perceived brightness of the red hue B*_{d}′ (L*_{d}, C*_{d}, h_{d}(R)) in an image as displayed on the image displaying unit reflecting amount of adjustment ΔC*ᵢₙ, and the perceived brightness in the BT.709 color reproduction range, i.e., the reference color reproduction range, B*₇₀₉(L*₇₀₉, C*₇₀₉, h₇₀₉(R)), respectively as in Equation 55:

B*_{d}′(L*_{d},C*_{d},h_{d}(R))=L*_{d}+(F(h_{d}(R))+k)×(C*_{d}+ΔC*ᵢₙ)

B*₇₀₉(L*₇₀₉,C*₇₀₉,h₇₀₉(R))=L*₇₀₉+(F(h₇₀₉(R))+k)×C*₇₀₉ (55)

The ratio P(L*₇₀₉, C*₇₀₉, h₇₀₉(R)) between the perceived brightness in the reference color gamut BT.709 in the red hue and the perceived brightness on the display screen with the amount of adjustment ΔC*ᵢₙ reflected is represented as Equation 56:

$$P ( {L}_{709}^{*} , {C}_{709}^{*} , {h}_{709} ( R ) ) = \frac{{L}_{d}^{*} + ( F ( {h}_{d} ( R ) ) + k ) \times ( {C}_{d}^{*} + Δ {C}_{i n}^{*} )}{{L}_{709}^{*} + ( F ( {h}_{709} ( R ) ) + k ) \times {C}_{709}^{*}} \qquad ( 56 )$$

For a given hue h₇₀₉ other than red whose chroma was adjusted by the user, the ratio P(L*₇₀₉, C*₇₀₉, h₇₀₉) between the perceived brightness in the reference color gamut BT.709 and the perceived brightness on the display screen is represented as in Equation 57:

$$P ( {L}_{709}^{*} , {C}_{709}^{*} , {h}_{709} ) = \frac{{L}_{d}^{*} + ( F ( {h}_{d} ) + k ) \times {C}_{d}^{*}}{{L}_{709}^{*} + ( F ( {h}_{709} ) + k ) \times {C}_{709}^{*}} \qquad ( 57 )$$

Then, as shown in Equation 58, the largest ratio P (L*₇₀₉, C*₇₀₉, h₇₀₉) between the perceived brightness in the reference color gamut BT.709 and the perceived brightness on the display screen with the amount of adjustment ΔC*ᵢₙ reflected among all hues including red, for which the user adjusted chroma, is defined as Pₘₐₓ(L*₇₀₉, C*₇₀₉). Although the maximum value is employed in the illustrated case, the minimum value, or a representative value between the minimum and maximum values, such as a mean value or median, may be adopted.

Pₘₐₓ(L*₇₀₉,C*₇₀₉=max{P(L*₇₀₉,C*₇₀₉,h₇₀₉)} (0≦h₇₀₉≦2π) (58)

The brightness B*ₒᵤₜ(L*₇₀₉, C*₇₀₉, h₇₀₉) perceived when the perceived brightness B*₇₀₉(L*₇₀₉, C*₇₀₉, h₇₀₉) with lightness L*₇₀₉ and chroma C*₇₀₉ in hue h₇₀₉ by the ratio Pₘₐₓ(L*₇₀₉, C*₇₀₉) is calculated as in Equation 59 such that the relative relationship of perceived brightness among hues is the same between the BT.709 color reproduction range (i.e., the reference color gamut) and the color reproduction range of the display screen reflecting the amount of adjustment ΔC*ᵢₙ:

B*ₒᵤₜ(L*₇₀₉,C*₇₀₉,h₇₀₉)=B*₇₀₉(L*₇₀₉,C*₇₀₉,h₇₀₉)×Pₘₐₓ(L*₇₀₉,C*₇₀₉) (59)

Further, the difference ΔB*ₒᵤₜ(L*₇₀₉, C*₇₀₉, h₇₀₉) between the perceived brightnesses B*₇₀₉(L*₇₀₉, C*₇₀₉, h₇₀₉) and B*ₒᵤₜ(L*₇₀₉, C*₇₀₉, h₇₀₉) is calculated as in Equation 60:

$$\begin{matrix}Δ {B}_{out}^{*} ( {L}_{709}^{*} , {C}_{709}^{*} , {h}_{709} ) = {B}_{out}^{*} ( {L}_{709}^{*} , {C}_{709}^{*} , {h}_{709} ) - \\ {B}_{709}^{*} ( {L}_{709}^{*} , {C}_{709}^{*} , {h}_{709} ) \\ = \{ {P}_{max} ( {L}_{709}^{*} , {C}_{709}^{*} ) - 1 \} \times \\ {B}_{709}^{*} ( {L}_{709}^{*} , {C}_{709}^{*} , {h}_{709} )\end{matrix} \qquad ( 60 )$$

Alternatively, the difference in perceived brightness ΔB*ₒᵤₜ(L*₇₀₉, C*₇₀₉, h₇₀₉) may be set as the difference in perceived brightness in the hue h₇₀₉(R) adjusted by the user, as shown in Equation 61:

$$Δ {B}_{out}^{*} ( {L}_{709}^{*} , {C}_{709}^{*} , {h}_{709} ) = {B}_{d}^{* ′} ( {L}_{d}^{*} , {C}_{d}^{*} , {h}_{d} ( R ) ) - {B}_{709}^{*} ( {L}_{709}^{*} , {C}_{709}^{*} , {h}_{709} ( R ) ) = {L}_{d}^{*} - {L}_{709}^{*} + ( F ( {h}_{d} ( R ) ) + k ) \times ( {C}_{d}^{*} + Δ {C}_{i n}^{*} ) - ( F ( {h}_{709} ( R ) ) + k ) \times {C}_{709}^{*} \qquad ( 61 )$$

Further, as in the first embodiment, the amount of lightness correction ΔL*ₒᵤₜ and the amount of chroma correction ΔC*ₒᵤₜ are set as the amount of correction 107 from the difference of perceived brightness ΔB*ₒᵤₜ(L*₇₀₉, C*₇₀₉, h₇₀₉), and the amount of correction 107 is sent to the adjusting unit 105 and the correcting unit 108. The adjusting unit 105 automatically changes the indication of amount of adjustment on the adjustment screen 302 in accordance with the amount of correction 107. The correcting unit 108 corrects (L*₇₀₉, C*₇₀₉, h₇₀₉), representing the converted signal 103, in accordance with the amount of correction 107 to obtain the corrected image signal 109, and sends it to the displaying unit 110. The displaying unit 110 displays the corrected image signal 109 on the display screen.

As described, in the present embodiment, when the user adjusts lightness, chroma, or hue, lightness and/or chroma of each hue is corrected so that the relative relationship of perceived brightnesses among the hues of the original image is maintained or so that the relative relationship is kept from varying. This enables image display that maintains perceived brightnesses among hues while achieving the image quality adjustment desired by the user.

### Eighth Embodiment

### When the Reference Color Gamut is Different from Panel Color Gamut

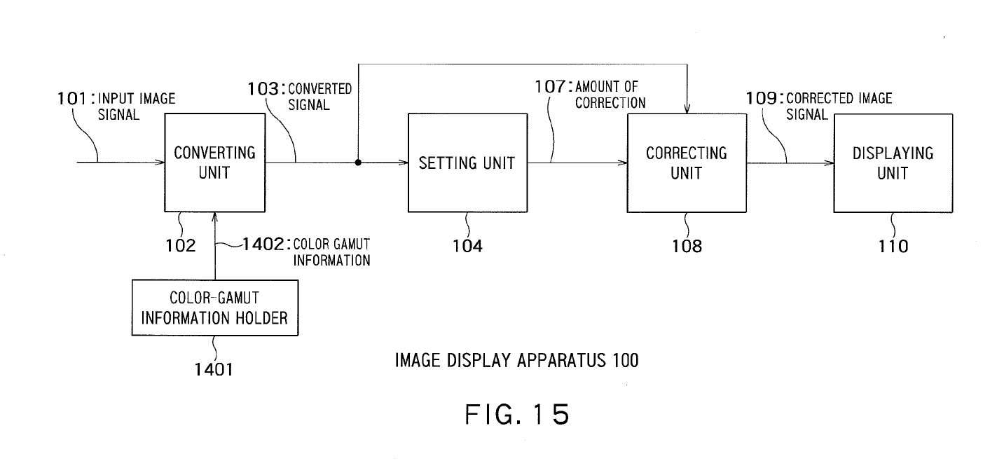

An eighth embodiment will be described. FIG. 15 shows the configuration of the image display apparatus in the eighth embodiment. The image display apparatus 100 according to the eighth embodiment is different from the seventh embodiment in that it does not include the image quality adjusting unit 105. In the eighth embodiment, the image quality adjusting unit 105 is not included, adjustment of image quality by the user is not performed, and the chroma or lightness of each hue is corrected so that the relative relationship of perceived brightness among hues in a standardized reference color reproduction range is maintained when displayed on the image displaying unit. The eighth embodiment illustrates a case where the color reproduction range defined by ITU-R BT.709 is used as the reference color reproduction range.

The converting unit 102 receives color gamut information 1402 of BT.709, which is the reference color reproduction range, from the color-gamut information holder 1401. The converting unit 102 calculates (L*₇₀₉, C*₇₀₉, h₇₀₉) and (L*_{d}, C*_{d}, h_{d}), which are the lightness, chroma, and hue converted in accordance with the BT.709-defined color reproduction range and the color reproduction range of the image displaying unit respectively, from the input image signal 101. The converting unit 102 sends (L*₇₀₉, C*₇₀₉, h₇₀₉) and (L*_{d}, C*_{d}, h_{d}) to the setting unit 104 as the converted signal 103. As conversion to lightness, chroma, and hue is similar to the first embodiment, description of how to calculate them is omitted.

The setting unit 104 first calculates the perceived brightness B*_{d} (L*_{d}, C*_{d}, h_{d}) perceived when the input image signal value (Rᵢₙ, Gᵢₙ, Bᵢₙ) is displayed by the image displaying unit and the perceived brightness B*₇₀₉(L*₇₀₉, C*₇₀₉, h₇₀₉) in the BT.709 color reproduction range, i.e., the reference color reproduction range, as in Equation 62:

B*_{d}(L*_{d},C*_{d},h_{d})=L*_{d}+(F(h_{d})+k)×C*_{d}

B*₇₀₉(L*₇₀₉,C*₇₀₉,h₇₀₉)=L*₇₀₉+(F(h₇₀₉)+k)×C*₇₀₉ (62)

The ratio P(L*₇₀₉, C*₇₀₉, h₇₀₉) between the perceived brightness in the reference color gamut BT.709 and the perceived brightness on the display screen is represented as in Equation 63:

$$P ( {L}_{709}^{*} , {C}_{709}^{*} , {h}_{709} ) = \frac{{L}_{d}^{*} + ( F ( {h}_{d} ) + k ) \times {C}_{d}^{*}}{{L}_{709}^{*} + ( F ( {h}_{709} ) + k ) \times {C}_{709}^{*}} \qquad ( 63 )$$

Then, as shown in Equation 64, the largest ratio P (L*₇₀₉, C*₇₀₉, h₇₀₉) between the perceived brightness in the reference color gamut BT.709 and the perceived brightness on the display screen among all hues is defined as Pₘₐₓ(L*₇₀₉, C*₇₀₉). Although the maximum value is employed in the illustrated case, the minimum value, or a representative value between the minimum and maximum values, such as a mean value or median, may be adopted.

Pₘₐₓ(L*₇₀₉,C*₇₀₉)=max{P(L*₇₀₉,C*₇₀₉,h₇₀₉)} (0≦h₇₀₉≦2π) (64)

The brightness B*ₒᵤₜ(L*₇₀₉, C*₇₀₉, h₇₀₉) perceived when the brightness B*₇₀₉(L*₇₀₉, C*₇₀₉, h₇₀₉) perceived with the lightness L*₇₀₉, chroma C*₇₀₉, and hue h₇₀₉ is multiplied by the ratio Pₘₐₓ(L*₇₀₉,C*₇₀₉) is calculated as shown in Equation 65, such that the relative relationship of perceived brightness among hues is the same in the reference BT.709 color reproduction range and the color reproduction range of the display screen:

B*ₒᵤₜ(L*₇₀₉,C*₇₀₉,h₇₀₉)=B*₇₀₉(L*₇₀₉,C*₇₀₉,h₇₀₉)×Pₘₐₓ(L*₇₀₉,C*₇₀₉) (65)

Further, the difference ΔB*ₒᵤₜ(L*₇₀₉, C*₇₀₉, h₇₀₉) between the perceived brightnesses B*₇₀₉(L*₇₀₉, C*₇₀₉, h₇₀₉) and B*ₒᵤₜ(L*₇₀₉, C*₇₀₉, h₇₀₉) is calculated as in Equation 66:

$$\begin{matrix}Δ {B}_{out}^{*} ( {L}_{709}^{*} , {C}_{709}^{*} , {h}_{709} ) = {B}_{out}^{*} ( {L}_{709}^{*} , {C}_{709}^{*} , {h}_{709} ) - \\ {B}_{709}^{*} ( {L}_{709}^{*} , {C}_{709}^{*} , {h}_{709} ) \\ = \{ {P}_{max} ( {L}_{709}^{*} , {C}_{709}^{*} ) - 1 \} \times \\ {B}_{709}^{*} ( {L}_{709}^{*} , {C}_{709}^{*} , {h}_{709} )\end{matrix} \qquad ( 66 )$$

Alternatively, ΔB*ₒᵤₜ(L*₇₀₉, C*₇₀₉, h₇₀₉) may be determined by calculating the difference ΔB*₇₀₉(L*₇₀₉, C*₇₀₉, h₇₀₉) between B*_{d} (L*_{d}, C*_{d}, h_{d}) and B*₇₀₉(L*₇₀₉, C*₇₀₉, h₇₀₉), which were determined by Equation 62, as shown in Equation 67, and defining the largest difference ΔB*₇₀₉(L*₇₀₉,C*₇₀₉,h₇₀₉) among all hues as ΔB*ₒᵤₜ(L*₇ₒ₉,C*₇₀₉,h₇₀₉), as shown by Equation 68. Although the maximum value is employed in the illustrated case, the minimum value, or a representative value between the minimum and maximum values, such as a mean value or median, may be adopted.

$$\begin{matrix}Δ {B}_{709}^{*} ( {L}_{709}^{*} , {C}_{709}^{*} , {h}_{709} ) = {B}_{d}^{*} ( {L}_{d}^{*} , {C}_{d}^{*} , {h}_{d} ) - {B}_{709}^{*} ( {L}_{709}^{*} , {C}_{709}^{*} , {h}_{709} ) = {L}_{d}^{*} - {L}_{709}^{*} + ( F ( {h}_{d} ) + k ) \times {C}_{d}^{*} - ( F ( {h}_{709} ) + k ) \times {C}_{709}^{*} & ( 67 ) \\ Δ {B}_{out}^{*} ( {L}_{709}^{*} , {C}_{709}^{*} , {h}_{709} ) = max \{ Δ {B}_{709}^{*} ( {L}_{709}^{*} , {C}_{709}^{*} , {h}_{709} ) \} ( 0 \leq {h}_{709} \leq 2 π ) & ( 68 )\end{matrix}$$

Further, as in the first embodiment, the amount of lightness correction ΔL*ₒᵤₜ and the amount of chroma correction ΔC*ₒᵤₜ are set as the amount of correction 107 based on the difference of perceived brightness ΔB*ₒᵤₜ(L*₇₀₉, C*₇₀₉, h₇₀₉), and the amount of correction 107 is sent to the correcting unit 108. The correcting unit 108 corrects (L*₇₀₉, C*₇₀₉, h₇₀₉), representing the converted signal 103, in accordance with the amount of correction 107 to obtain the corrected image signal 109, and sends it to the displaying unit 110. The displaying unit 110 displays the corrected image signal 109 on the display screen.

As described above, according to the eighth embodiment, by correcting the lightness or chroma of each hue so that the relative relationship of perceived brightness among hues in the color reproduction range of the display screen is the same as the relative relationship of perceived brightness among hues in the reference color gamut, it is possible to achieve image display that maintains the relative relationship of perceived brightness among hues of the reference color reproduction range even on a display device having a different color reproduction range.

### Ninth Embodiment

### When the Reference Color Gamut is Different from Panel Color Gamut

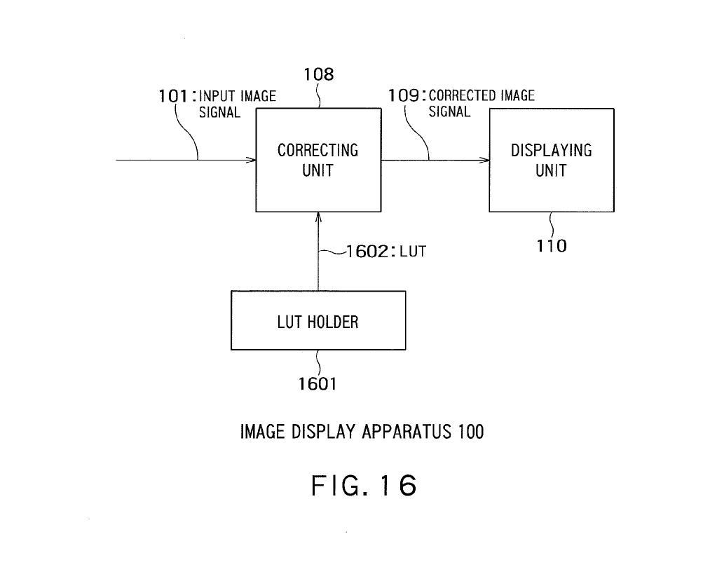

A ninth embodiment will be described. FIG. 16 shows the configuration of the image display apparatus in the ninth embodiment. The image display apparatus 100 of the ninth embodiment includes an LUT holder 1601, a correcting unit 108, and a displaying unit 110.

In the eighth embodiment, corrected image signal values obtained by applying correction to input image signal values (Rᵢₙ, Gᵢₙ, Bᵢₙ) with the amount of correction 107 ΔB*ₒᵤₜ(L*₇₀₉, C*₇₀₉, h₇₀₉) for perceived brightness is represented as (Rₒᵤₜ, Gₒᵤₜ, Bₒᵤₜ). In the eighth embodiment, since image quality adjustment by the user is not performed, if reference color gamut information (specifically, transformation matrix M) and color gamut information for the display screen (specifically, transformation matrix L) are known, the amount of brightness correction 107 ΔB*ₒᵤₜ(L*₇₀₉, C*₇₀₉, h₇₀₉) for the input image signal values (Rᵢₙ, Gᵢₙ, Bᵢₙ) is uniquely determined and further the corrected image signal values (Rₒᵤₜ, Gₒᵤₜ, Bₒᵤₜ) are uniquely determined.

Thus, from the reference color gamut information and color gamut information of the display screen, the corrected image signal values (Rₒᵤₜ, Gₒᵤₜ, Bₒᵤₜ) for the input image signal values (Rᵢₙ, Gᵢₙ, Bᵢₙ) is calculated in advance, and the relationship between (Rᵢₙ, Gᵢₙ, Bᵢₙ) and (Rₒᵤₜ, Gₒᵤₜ, Bₒᵤₜ) is kept in an LUT. By referencing the LUT, the corrected image signal values (Rₒᵤₜ, Gₒᵤₜ, Bₒᵤₜ) are directly calculated from the input image signal value (Rᵢₙ, Gᵢₙ, Bᵢₙ).

Here, corrected image signal values may be calculated for all possible input image signal values (for example, 256×256×256 signal values when RGB subpixels is each represented in 8 bits) and an LUT storing their correspondence may be used to determine the corrected image signal values. Alternatively, an LUT that holds the correspondence between representative values of input image signal values and corresponding corrected image signal values may be prepared, and the final corrected image signal value may be determined by interpolating plural corrected image signal values obtained by reference to the LUT.

As the processing for determining the corrected image signal values from the input image signal values is similar to the eighth embodiment, detailed description of how to calculate corrected image signal values is omitted. The difference of the ninth embodiment from the eighth embodiment is that the corrected image signal values are determined by referencing a prepared LUT contrary to the eighth embodiment which determines the corrected image signal values by calculation.

The correcting unit 108 calculates the corrected image signal 109 from the input image signal 101 with reference to the LUT 1602, and sends it to the displaying unit 110. The displaying unit 110 displays the corrected image signal 109 on the display screen.

As described, according to the ninth embodiment, by maintaining corrected image information with perceived brightness corrected in an LUT in advance in association with an input image, image display is enabled that maintains the relative relationship of perceived brightness among hues of the reference color reproduction range even on a display device having a different color reproduction range without involving complicated processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image display apparatus comprising:
a setting unit configured to set an amount of correction value for at least one of lightness and chroma for each hues, wherein the amount of correction values are determined so that a relative relationship of evaluation values among the hues is kept from varying before and after correction, the evaluation values being values defined depending on lightness and chroma for the hues;
a correcting unit configured to obtain a corrected image by correcting at least one of the lightness and the chroma of the input image according to the amount of correction; and
a displaying unit to display the corrected image.

2. The apparatus according to claim 1, wherein the evaluation values represent brightness that is defined based on lightness and chroma.

3. The apparatus according to claim 2, wherein
the setting unit determines, for each pair of values of the lightness and the chroma, the amount of correction so that the relative relationship of the brightness among the hues is kept from varying, and
the correcting unit performs correction by using the amount of correction corresponding to the values of the lightness and the chroma for each hue.

4. The apparatus according to claim 2, wherein the setting unit
calculates, for each of at least two hues of the input image, a difference between first brightness and second brightness, the first brightness being brightness obtained when at least one of lightness and chroma is corrected with a corresponding amount of correction, and the second brightness being brightness before the correction, and
sets an amount of correction for said at least one of the lightness and the chroma for each of the hues, based on a representative value of each calculated difference.

5. The apparatus according to claim 2, wherein a first relative relationship is a relative relationship of brightness among the hues in a first color reproduction range capable of being reproduced by the displaying unit, and a second relative relationship is a relative relationship of brightness among the hues in a second color reproduction range different from the first color reproduction range,
the setting unit sets the amount of correction so that the first relative relationship of the corrected image is kept from varying from the second relative relationship of the input image.

6. The apparatus according to claim 1, wherein the setting unit sets the amount of correction values for each of other hues, when at least one of lightness and chroma is corrected for one of hues of an input image.

7. The apparatus according to claim 6, further comprising:
an adjusting unit configured to display on the displaying unit an adjustment screen which enables a user to specify an adjustment of lightness, chroma, or brightness for at least one hue, wherein
the setting unit sets an amount of correction for the lightness or chroma of said one hue based on an amount of adjustment specified by the user.

8. The apparatus according to claim 7, wherein the adjusting unit displays, on the adjustment screen, information representing amounts of adjustment corresponding to amounts of correction determined by the setting unit for other hues than said one hue.

9. The apparatus according to claim 7, wherein said one hue is the hue of a pixel specified by the user in the input image.

10. The apparatus according to claim 7, wherein
an adjustment of lightness, chroma, or brightness is specified commonly for at least two hues, wherein
the setting unit calculates, for each of the at least two hues of the input image, a difference between first brightness and second brightness, the first brightness being brightness obtained by correcting at least one of lightness and chroma with an amount of correction corresponding to an amount of the adjustment specified by the user, and the second brightness being brightness before correction, and
sets an amount of correction for each of the hues of the input image, based on a representative value of each calculated difference.

11. The apparatus according to claim 7, wherein
a first relative relationship is a relative relationship of brightness among the hues in a first color reproduction range capable of being reproduced by the displaying unit, and a second relative relationship is a relative relationship of brightness among the hues in a second color reproduction range different from the first color reproduction range,
the setting unit sets the amount of correction for each of the hues so that the first relative relationship of the corrected image is kept from varying from the second relative relationship of the input image.

12. The apparatus according to claim 4, wherein the representative value is a maximum value.

13. The apparatus according to claim 7, wherein the adjustment screen includes at least one slide bar operable by the user to specify an adjustment amount of lightness, chroma, or brightness.

14. The apparatus according to claim 9, wherein the pixel is specified by means of a pointer.

15. The apparatus according to claim 10, wherein the representative value is a maximum value.

16. An image display apparatus comprising:
a display unit to configured to display an image, and
a look-up table including input image signal values and corrected image signal values,
a correcting unit configured to correct an input image by using the look-up table to obtain an corrected image,
wherein
the display unit displays the corrected image,
a first relative relationship is a relative relationship of brightness among the hues in a first color reproduction range capable of being reproduced by the displaying unit, the brightness being defined based on lightness and chroma,
a second relative relationship is a relative relationship of brightness among the hues in a second color reproduction range different from the first color reproduction range, the brightness being defined based on lightness and chroma, and
the look-up table is configured so that the first relative relationship of the corrected image is kept from varying from the second relative relationship of the input image.

17. An image display method comprising:
setting an amount of correction value for at least one of lightness and chroma for each hues, wherein the amount of correction values are determined so that a relative relationship of evaluation values among the hues is kept from varying before and after correction, the evaluation values being values defined depending on lightness and chroma for the hues;
obtaining a corrected image by correcting at least one of the lightness and the chroma of the input image according to the amount of correction; and
displaying the corrected image.
